(19) United States
(12) Patent Application Publication
(10) Pub. No.: US 2025/0257428 A1
(43) Pub. Date: Aug. 14, 2025

(54) MAGNETIC WIRE, COMPOSITE MAGNETIC WIRE, METHOD FOR MANUFACTURING MAGNETIC WIRE, AND METHOD FOR MANUFACTURING COMPOSITE MAGNETIC WIRE

(71) Applicants: SUMITOMO ELECTRIC INDUSTRIES, LTD., Osaka (JP); DAIKOKU ELECTRIC WIRE CO., LTD., Tochigi (JP)

(72) Inventors: Makoto FUJIMOTO, Osaka (JP); Tooru TANJI, Osaka (JP)

(73) Assignees: SUMITOMO ELECTRIC INDUSTRIES, LTD., Osaka (JP); DAIKOKU ELECTRIC WIRE CO., LTD., Tochigi (JP)

(21) Appl. No.: 18/704,880

(22) PCT Filed: Oct. 25, 2022
(86) PCT No.: PCT/JP2022/039747

§ 371 Date: Apr. 25, 2024

(30) Foreign Application Priority Data
Nov. 1, 2021 (JP) 2021-179074

(51) Int. Cl. C22C 19/07; B21C 1/02; C22C 30/00; C22F 1/10; C22F 1/16; H01B 13/00; H01F 1/147; H01F 41/00

(52) U.S. Cl. CPC C22C 19/07; B21C 1/02; C22C 30/00; C22F 1/10; C22F 1/16; H01B 13/0016; H01F 1/147; H01F 41/00

(57) ABSTRACT

A magnetic wire made of an alloy containing iron and cobalt as main components, wherein the magnetic wire has a structure including at least an α phase of the α phase and a γ phase, the structure has a high angle grain boundary having a misorientation of 15° or more, the proportion of the area of the α phase relative to the total area of the α phase and the γ phase in a cross section of the magnetic wire is 90% or more, the average crystal grain size of the α phase in the cross section is 2.5 μm or less, and the proportion of the length of the high angle grain boundary relative to the total length of grain boundaries in the structure in the cross section is 60% or more.

### TECHNICAL FIELD

The present disclosure relates to a magnetic wire, a composite magnetic wire, a method for manufacturing a magnetic wire, and a method for manufacturing a composite magnetic wire.

The present application claims priority based on Japanese Patent Application No. 2021-179074 filed on Nov. 1, 2021, and the entire contents described in the Japanese Patent Application are incorporated herein by reference.

### BACKGROUND ART

A magnetic wire that may cause a large Barkhausen jump phenomenon has conventionally been utilized in a magnetic sensor. The above magnetic sensor includes a core made of a magnetic wire, and a coil wound around the outer periphery of the core. When a certain external magnetic field is applied, the above magnetic wire causes a rapid magnetic reversal regardless of the change rate of the external magnetic field. A pulse voltage is generated on the above coil by electromagnetic induction accompanied with the rapid magnetic reversal. The magnetic sensor detects this pulse voltage as output.

Patent Literature 1 to Patent Literature 4 each disclose a magnetic wire. In these Patent Literatures, magnetic wires manufactured by subjecting an iron-nickel alloy wire or an iron-cobalt-vanadium alloy wire to heat treatment and twisting are described. Patent Literature 5 and Patent Literature 6 each disclose a composite magnetic wire including a coating material on the outer peripheral surface of the magnetic wire. Patent Literature 5 describes that a ferromagnetic wire having high coercive force is coated with a ferromagnetic layer having low coercive force and high residual magnetization. Patent Literature 6 describes that a ferromagnetic body is coated with a non-magnetic layer.

### CITATION LIST

### Patent Literature

PTL 1: Japanese Patent Laying-Open No. 47-008956
PTL 2: Japanese Patent Laying-Open No. 53-137641
PTL 3: Japanese Patent Laying-Open No. 2006-114857
PTL 4: Japanese Patent Laying-Open No. 2019-132698
PTL 5: Japanese Patent Laying-Open No. 54-050373
PTL 6: Japanese Patent Laying-Open No. 4-305904

### SUMMARY OF INVENTION

The magnetic wire of the present disclosure is
a magnetic wire made of an alloy containing iron and cobalt as main components, wherein
the magnetic wire has a structure comprising at least an α phase of the α phase and a γ phase,
the structure has a high angle grain boundary having a misorientation of 15° or more,
a proportion of an area of the α phase relative to a total area of the α phase and the γ phase in a cross section of the magnetic wire is 90% or more,
an average crystal grain size of the α phase in the cross section is 2.5 μm or less, and
a proportion of a length of the high angle grain boundary relative to a total length of grain boundaries in the structure in the cross section is 60% or more.

### BRIEF DESCRIPTION OF DRAWINGS

FIG. 1 is a schematic perspective view of a magnetic wire according to an embodiment.

FIG. 2 is a schematic diagram of a structure of the magnetic wire according to the embodiment.

FIG. 3 is a schematic diagram of grain boundaries of the structure of the magnetic wire according to the embodiment.

FIG. 4 is a schematic perspective view of a composite magnetic wire according to an embodiment.

FIG. 5 is a schematic cross-sectional view of the composite magnetic wire according to the embodiment.

FIG. 6 is a schematic diagram of twist marks in the composite magnetic wire according to the embodiment.

FIG. 7 is a phase map of Sample No. 1 obtained by the EBSD method.

FIG. 8 is an image quality (IQ) map of Sample No. 1 obtained by the EBSD method.

### DETAILED DESCRIPTION

### Problem to be Solved by the Present Disclosure

The magnetic wire that causes a large Barkhausen jump phenomenon is required to have further high performance.

The performance of the magnetic sensor described above largely depends on the characteristics of the magnetic wire used in the core. To achieve miniaturization and high output of a magnetic sensor, a magnetic wire that allows high output to be obtained is desired.

An object of the present disclosure is to provide a magnetic wire excellent in output characteristics. Another object of the present disclosure is to provide a composite magnetic wire excellent in output characteristics. Another object of the present disclosure is to provide a method for manufacturing a magnetic wire, the method being capable of manufacturing a magnetic wire excellent in output characteristics. Another object of the present disclosure is to provide a method for manufacturing a composite magnetic wire, the method being capable of manufacturing a composite magnetic wire excellent in output characteristics.

### Advantageous Effect of the Present Disclosure

The magnetic wire of the present disclosure is excellent in output characteristics.

### DESCRIPTION OF EMBODIMENTS

In general, the magnetic wire has a high uniaxial anisotropy along the length of the magnetic wire, and the higher the energy of a magnetic domain wall, the more easily the magnetic wire is magnetized along the length of the magnetic wire, so that a magnetic single domain structure is easily formed. As a result, a large Barkhausen phenomenon easily occurs. That is, the larger the uniaxial anisotropy of the magnetic wire and the energy of the magnetic domain wall is, the more the output characteristics of the magnetic wire are improved. To enhance the uniaxial anisotropy of the magnetic wire and the energy of the magnetic domain wall, the magnetic wire is twisted. In the twisted magnetic wire, tensile residual stress along the length of the magnetic wire is generated inside the magnetic wire. As a result, as the uniaxial anisotropy of the magnetic wire increases, the energy of the magnetic domain wall increases simultaneously. In addition, the smaller the length of the magnetic wire is, the more easily the variation in output is increased. This is considered because the influence of the diamagnetic field generated in the magnetic wire increases, which makes the formation of a magnetic single domain structure difficult.

The present inventors have intensively studied to improve the output characteristics of the magnetic wire, and as a result, have found as follows. By subjecting a wire that is the material of a magnetic wire to heat treatment at a specific temperature, the wire is made to have a specific structure in which an α phase and a γ phase coexist. Then, the present inventors have found that, in the magnetic wire manufactured by twisting the wire having the above specific structure, high output can be obtained and the variation in output is small. In addition, it has been found that the magnetic wire twisted in a state of having the above specific structure has an unconventional new structure. Specifically, in the structure of the magnetic wire, each of three requirements: the area proportion of the α phase, the average crystal grain size of the α phase, and the proportion of the length of the high angle grain boundary satisfies a specific range.

The present disclosure is based on the above findings. The embodiments of the present disclosure will be first listed and described.

(1) The magnetic wire according to an embodiment of the present disclosure is
a magnetic wire made of an alloy containing iron and cobalt as main components, wherein
the magnetic wire has a structure comprising at least an α phase of the α phase and a γ phase,
the structure has a high angle grain boundary having a misorientation of 15° or more,
a proportion of an area of the α phase relative to a total area of the α phase and the γ phase in a cross section of the magnetic wire is 90% or more,
an average crystal grain size of the α phase in the cross section is 2.5 μm or less, and
a proportion of a length of the high angle grain boundary relative to a total length of grain boundaries in the structure in the cross section is 60% or more.

The magnetic wire of the present disclosure has a specific structure in which each of the area proportion of the α phase, the average crystal grain size of the α phase, and the proportion of the length of the high angle grain boundary satisfies the above range. The magnetic wire of the present disclosure having a specific structure is excellent in output characteristics. The α phase as used herein is α phase determined to have a crystal structure of body-centered cubic lattice (BCC) by a structure analysis by the electron back scattered diffraction pattern (EBSD) method. The α phase is, for example, at least one of a ferrite phase and a martensite phase. The α phase includes a B2 ordered phase. The B2 ordered phase is α phase in which Fe atoms and Co atoms are present in a regularly arranged state. The γ phase as used herein is α phase determined to have a crystal structure of face-centered cubic lattice (FCC) by a structure analysis by the EBSD method. The γ phase is, for example, an austenite phase. The methods for measuring the area proportion of the α phase, the average crystal grain size of the α phase, and the proportion of the length of the high angle grain boundary are described below.

Since high output can be obtained in the magnetic wire of the present disclosure, the above-described magnetic sensor can achieve high output when the magnetic wire of the present disclosure is used for the core of the magnetic sensor. In addition, in the magnetic wire of the present disclosure, high output can be obtained and the variation in output is small. Even when the magnetic wire of the present disclosure is miniaturized by reducing the diameter of the magnetic wire or reducing the length of the magnetic wire, stable output is easily obtained. Thus, miniaturization of the magnetic sensor can be achieved.

(2) In the magnetic wire of the above (1),
the alloy may have a composition comprising 40% by mass or more and 70% by mass or less of cobalt, 2% by mass or more and 12% by mass or less of vanadium, and the balance with iron and inevitable impurities.

In the magnetic wire of the above (2) comprising an alloy having the above specific composition, high output is easily obtained.

(3) In the magnetic wire of the above (1),
the alloy may have a composition comprising 40% by mass or more and 70% by mass or less of cobalt and 2% by mass or more and 12% by mass or less of vanadium, and further comprising at least one selected from the group consisting of 0.1% by mass or more and 1.0% by mass or less of silicon, 0.05% by mass or more and 0.5% by mass or less of titanium, 0.2% by mass or more and 1.0% by mass or less of aluminum, and 0.2% by mass or more and 1.2% by mass or less of manganese, and the balance with iron and inevitable impurities.

In the magnetic wire of the above (3), further high output is easily obtained.

(4) In the magnetic wire of any of the above (1) to (3),
the structure may further have a Σ3 grain boundary, and
the proportion of the length of the Σ3 grain boundary relative to the total length of the grain boundaries may be 5% or more.

In the magnetic wire of the above (4) having a specific structure in which the proportion of the length of the Σ3 grain boundary further satisfies the above range in addition to the above-described three requirements, high output can be obtained and stable output is easily obtained. The method for measuring the proportion of the length of the Σ3 grain boundary will be described below.

(5) In the magnetic wire of any of the above (1) to (4),
the kernel average misorientation (KAM) value of the α phase in the cross section may be 0.45° or more.

In the magnetic wire of the above (5) having a specific structure in which the KAM value of the α phase satisfies the above range in addition to the above-described three requirements, high output can be obtained and stable output is easily obtained. The method for measuring the KAM value of a phase will be described below.

(6) In the magnetic wire of any of the above (1) to (5),
the diameter of the magnetic wire may be 0.1 mm or more and 1.0 mm or less, and
the length of the magnetic wire may be 25 mm or less.

The smaller the diameter or the length of the magnetic wire is, the more the volume of the magnetic wire is reduced, so that the output of the magnetic wire is reduced. In particular, the smaller the length of the magnetic wire is, the larger the influence of the diamagnetic field is, so that the output of the magnetic wire easily varies. In the magnetic wire of the present disclosure, high output can be obtained and the variation in output is small, so that stable output is easily obtained even when the diameter of the magnetic wire is made small or the length of the magnetic wire is made small. The magnetic wire of the above (6) easily ensures sufficient output characteristics even with a small diameter or length. When the magnetic wire of the above (6) is used for the core of the magnetic sensor, miniaturization of the magnetic sensor can be achieved.

(7) The composite magnetic wire according to an embodiment of the present disclosure is,
a composite magnetic wire comprising a core material, and a coating material for covering an outer peripheral surface of the core material, wherein
the core material is made of the magnetic wire according to any one of the above (1) to (6), and
a proportion of a diameter of the core material relative to a diameter of the composite magnetic wire is 45% or more and 95% or less.

The composite magnetic wire of the present disclosure having a core material made of the above magnetic wire of the present disclosure is excellent in output characteristics. In the composite magnetic wire of the present disclosure, high output can be obtained, so that the magnetic sensor can achieve high output when the composite magnetic wire of the present disclosure is used for the core of the above-described magnetic sensor. In addition, in the composite magnetic wire of the present disclosure, high output can be obtained and the variation in output is small. Even when the composite magnetic wire of the present disclosure is miniaturized by reducing the diameter of the composite magnetic wire or reducing the length of the composite magnetic wire, stable output is easily obtained. Thus, miniaturization of the magnetic sensor can be achieved.

(8) In the composite magnetic wire of the above (7),
the melting point of the coating material may be more than 850° C.

In the manufacturing process, the composite magnetic wire of the above (8) can be subjected to first heat treatment in a state where the core material is coated with the coating material.

(9) In the composite magnetic wire of the above (7) or (8),
the Vickers hardness of the coating material may be 200 HV or more.

In the composite magnetic wire of the above (9), tensile residual stress is easily introduced to the core material by twisting. As a result, the uniaxial anisotropy of the core material is easily increased, and the output characteristics of the core material are easily improved. In the composite magnetic wire of the above (9), further high output is easily obtained.

(10) In the composite magnetic wire of any of the above (7) to (9),
the outer peripheral surface of the coating material may have a twist mark, and
the angle of the twist mark relative to the axis line of the composite magnetic wire may be 4° or more and 60° or less.

In the composite magnetic wire having a twist mark, the tensile residual stress introduced to the core material by twisting is easily maintained. Further, when the angle of the twist mark is within the above range, the tensile residual stress along the length is easily uniformly introduced over the total length of the core material. As a result, the output characteristics of the core material easily improved. In the composite magnetic wire of the above (10), further high output is easily obtained.

(11) The method for manufacturing a magnetic wire according to an embodiment of the present disclosure comprises:
drawing a material made of an alloy containing iron and cobalt as main components to obtain a drawn wire,
subjecting the wire to first heat treatment to obtain a first heat treated material, and
twisting the first heat treated material, wherein
the first heat treatment is performed under such conditions that a structure of the alloy of the first heat treated material comprises an α phase and a γ phase and a proportion of an area of the α phase relative to a total area of the α phase and the γ phase in a cross section of the first heat treated material is 90% or more.

The method for manufacturing a magnetic wire of the present disclosure can manufacture a magnetic wire excellent in output characteristics. This is because the structure of the first heat treated material is controlled by the first heat treatment to be a specific structure in which the α phase and the γ phase coexist. By twisting the first heat treated material having the above specific structure, a magnetic wire having high output characteristics can be obtained.

(12) In the method for manufacturing a magnetic wire of the above (11),
the twisting may be performed under such conditions that the amount of strain on a surface of the twisted first heat treated material is 1.0 or more and 4.5 or less.

According to the manufacturing method of the above (12), a magnetic wire having high output characteristics can be stably manufactured.

(13) The method for manufacturing a magnetic wire of the above (11) or (12) may comprise
subjecting the first heat treated material after being twisted to second heat treatment after the twisting, or subjecting the first heat treated material during being twisted to second heat treatment simultaneous with the twisting.

The first heat treated material after being twisted or the first heat treated material during being twisted may be subjected to heat treatment at a temperature of 150° C. or more and 400° C. or less in the second heat treatment.

According to the manufacturing method of the above (13), the output characteristics of the magnetic wire can be enhanced.

(14) In the method for manufacturing a magnetic wire of any of the above (11) to (13),
the drawn wire may be subjected to heat treatment at a temperature of more than 750° C. and 850° C. or less in the first heat treatment.

According to the manufacturing method of the above (14), the structure of the first heat treated material is easily controlled to have the above-described specific structure.

(15) In the method for manufacturing a magnetic wire of any of the above (11) to (14),
the obtaining a drawn wire may comprise drawing the material at a rate of work of 10% or more.

According to the manufacturing method of the above (15), a magnetic wire having high output characteristics is easily obtained.

(16) The method for manufacturing a composite magnetic wire according to an embodiment of the present disclosure comprises:
coating an outer peripheral surface of a core material made of an alloy containing iron and cobalt as main components with a coating material to obtain a coated wire,
drawing the coated wire to obtain a drawn wire,
subjecting the drawn wire to first heat treatment to obtain a first heat treated material, and
twisting the first heat treated material, wherein
the first heat treatment is performed under such conditions that a structure of the alloy of the core material in the first heat treated material comprises an α phase and a γ phase and a proportion of an area of the α phase relative to a total area of the α phase and the γ phase in a cross section of the core material is 90% or more.

The method for manufacturing a composite magnetic wire of the present disclosure can manufacture a composite magnetic wire excellent in output characteristics. This is because the structure of the core material in the first heat treated material is controlled by the first heat treatment to be a specific structure in which the α phase and the γ phase coexist. According to the method for manufacturing a composite magnetic wire of the present disclosure, a composite magnetic wire having high output characteristics can be obtained by twisting the first heat treated material.

In the method for manufacturing a composite magnetic wire of the present disclosure, twisting is performed in a state where the core material is coated with the coating material. When the composite magnetic wire is twisted, the core material is pulled by the coating material in the vicinity of the outer peripheral surface of the core material, and the core material is stretched along the length of the core material. Tensile residual stress along the length of the core material is introduced to the core material by twisting. As a result, the tensile residual stress increases, and the uniaxial anisotropy of the core material increases. Since the uniaxial anisotropy of the core material increases, the output characteristics of the core material are improved.

(17) In the method for manufacturing a composite magnetic wire of the above (16),
the twisting may be performed under such conditions that an amount of strain on a surface of the twisted first heat treated material is 0.8 or more and 3.0 or less.

According to the manufacturing method of the above (17), a composite magnetic wire having high output characteristics can be stably manufactured.

(18) The method for manufacturing a composite magnetic wire of the above (16) or (17) may comprise
subjecting the first heat treated material after being twisted to second heat treatment after the twisting, or subjecting the first heat treated material during being twisted to second heat treatment simultaneous with the twisting.

The first heat treated material after being twisted or the first heat treated material during being twisted may be subjected to heat treatment at a temperature of 150° C. or more and 400° C. or less in the second heat treatment.

According to the manufacturing method of the above (18), the output characteristics of the composite magnetic wire can be enhanced.

(19) In the method for manufacturing a composite magnetic wire of any of the above (16) to (18),
the drawn wire may be subjected to heat treatment at a temperature of more than 750° C. and 850° C. or less in the first heat treatment.

According to the manufacturing method of the above (19), the structure of the core material in the first heat treated material is easily controlled to have the above-described specific structure.

(20) In the method for manufacturing a composite magnetic wire of any of the above (16) to (19),
the obtaining a drawn wire may comprise drawing the core material of the coated wire at a rate of work of 10% or more.

According to the manufacturing method of the above (20), a composite magnetic wire having high output characteristics is easily obtained.

### Detail of Embodiment of the Present Disclosure

Hereinafter, the embodiments of the present disclosure will be specifically described with reference to the drawings. In the drawings, the same reference signs refer to the same objects.

### [Magnetic Wire]

### Summary

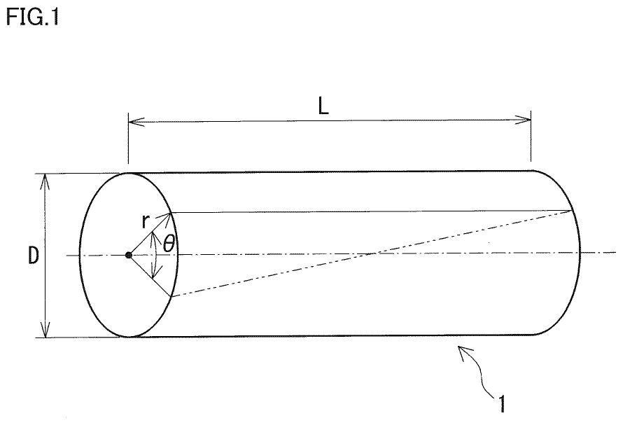

With reference to FIG. 1 to FIG. 3, a magnetic wire 1 according to an embodiment is described. Magnetic wire 1 causes a large Barkhausen jump phenomenon when an external magnetic field is applied. Magnetic wire 1 is made of an alloy containing iron and cobalt as main components. Magnetic wire 1 having a specific structure 10 is excellent in output characteristics. Hereinafter, magnetic wire 1 of an embodiment will be described in detail.

In the following description, elements are represented by element symbols. Fe is iron. Co is cobalt. Vis vanadium. Si is silicon. Ti is titanium. Al is aluminum. Mn is manganese. Ni is nickel. Cris chrome. Mo is molybdenum. Nb is niobium. W is tungsten. Cu is copper. The content of an element is the proportion of the element contained in the alloy represented by percent by mass. The whole alloy is taken as 100% by mass.

### (Composition)

The composition of the alloy that constitutes magnetic wire 1 contains Fe and Co as main components. The term “contain Fe and Co as main components” means that Fe and Co are contained in an amount of 75% by mass or more in total. Magnetic wire 1 can obtain good output characteristics by twisting. The melting point of the alloy that constitutes magnetic wire 1 is, for example, about 1300° C. The composition of magnetic wire 1 may contain 80% by mass or more, or further, 85% by mass or more of Fe and Co in total. The composition of magnetic wire 1 may contain an additive element other than Fe and Co. Specific examples of the composition include a composition comprising 40% by mass or more and 70% by mass or less of Co, 2% by mass or more and 12% by mass or less of V, and the balance with Fe and inevitable impurities. Magnetic wire 1 made of an alloy having such a composition can easily obtain high output. When the content of Co is 40% by mass or more and 70% by mass or less, output characteristics are improved. When the content of Vis 2% by mass or more, output characteristics are improved and twisting is easily performed in the manufacturing process. Even when more than 12% by mass of Vis contained, a higher effect cannot be obtained, and thus, the upper limit of the content of Vis 12% by mass. The content of Co may be 42% by mass or more and 63% by mass or less, or may further be 45% by mass or more and 55% by mass or less, or 48% by mass or more and 53% by mass or less. The content of V may be 5% by mass or more and 12% by mass or less, or may further be 7% by mass or more and 11.5% by mass or less, or 8.5% by mass or more and 11% by mass or less.

Further, the composition of magnetic wire 1 may be a composition containing one or more elements selected from the group consisting of Si, Ti, Al, and Mn, in addition to Co and V, and the balance with Fe and inevitable impurities. These elements have an effect of improving the output characteristics of magnetic wire 1. The content of Si is more than 0% by mass and 1.0% by mass or less. The content of Ti is more than 0% by mass and 0.5% by mass or less. The content of Al is more than 0% by mass and 1.0% by mass or less. The content of Mn is more than 0% by mass and 1.2% by mass or less. To obtain the above effect, the content of Si may be 0.1% by mass or more, or may further be 0.15% by mass or more. To obtain the above effect, the content of Ti may be 0.05% by mass or more, or may further be 0.08% by mass or more. To obtain the above effect, the content of Al may be 0.2% by mass or more, or may further be 0.3% by mass or more. To obtain the above effect, the content of Mn may be 0.2% by mass or more, or may further be 0.4% by mass or more. The content of Si contained as an inevitable impurity is less than 0.1% by mass. The content of Ti contained as an inevitable impurity is less than 0.05% by mass. The content of Al contained as an inevitable impurity is less than 0.2% by mass. The content of Mn contained as an inevitable impurity is less than 0.2% by mass. Even when each of the above elements is excessively contained, a higher effect cannot be expected. The content of Si may be 0.1% by mass or more and 0.7% by mass or less, or may further be 0.15% by mass or more and 0.5% by mass or less. The content of Ti may be 0.05% by mass or more and 0.4% by mass or less, or may further be 0.08% by mass or more and 0.3% by mass or less. The content of Al may be 0.2% by mass or more and 0.9% by mass or less, or may further be 0.3% by mass or more and 0.8% by mass or less. The content of Mn may be 0.2% by mass or more and 1.1% by mass or less, or may further be 0.3% by mass or more and 1.0% by mass or less.

In addition, the composition of magnetic wire 1 may contain one or more elements selected from the group consisting of Ni, Cr, Mo, Nb, W, and Cu, in addition to the above elements. These elements have an effect of improving the output characteristics of the magnetic wire. The content of each of these elements is, for example, more than 0% by mass and 1.0% by mass or less, or further, 0.2% by mass or more and 0.8% by mass or less.

The composition of magnetic wire 1 can be determined by, for example, inductively coupled plasma optical emission spectrometry (ICP optical emission spectrometry), or energy dispersive x-ray spectroscopy (the EDX method).

### (Structure)

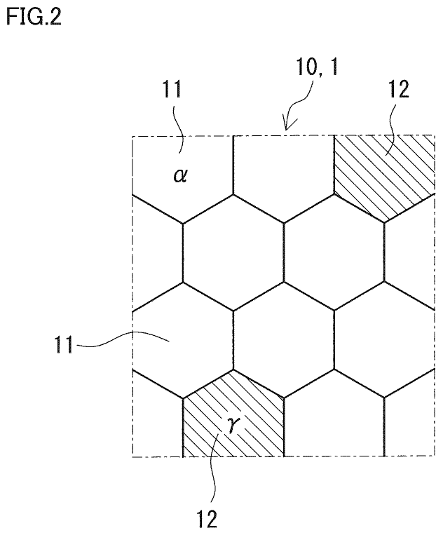

Structure 10 of the alloy that constitutes magnetic wire 1 contains at least an α phase 11, as shown in FIG. 2. Structure 10 shown in FIG. 2 comprises α phase 11 and a γ phase 12. FIG. 2 schematically illustrates structure 10 in a cross section of magnetic wire 1. In FIG. 2, hatching is applied to γ phase 12 for easy understanding. α phase 11 is at least one selected from, for example, a ferrite phase, a martensite phase, and a B2 ordered phase. The reason why α phase 11 is defined as described above is because it is difficult to differentiate the ferrite phase, the martensite phase, and the B2 ordered phase by a typical structure analysis by the EBSD method. Y phase 12 is, for example, an austenite phase. Structure 10 may comprise no γ phase 12, or may comprise γ phase 12. That is, structure 10 may be a structure comprising substantially only α phase 11 of α phase 11 and γ phase 12, or may be a structure in which two phases, α phase 11 and γ phase 12, coexist. Structure 10 may comprise an inevitable phase which is not shown, in addition to α phase 11 and γ phase 12. The inevitable phase is, for example, an inevitably produced precipitation phase.

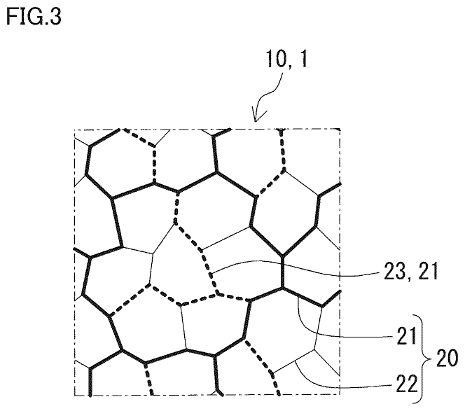

Further, structure 10 of magnetic wire 1 has a high angle grain boundary 21 and a Σ3 grain boundary 23, as shown in FIG. 3. High angle grain boundary 21 is the grain boundary having a misorientation of 15° or more among grain boundaries 20. The 23 grain boundary is a coincidence boundary having a 2 value which is crystallographically defined based on the CSL theory (Kronberg et al, Trans. Met. Soc. AIME, 1949, 185, 501), of 3. In the determination of the coincidence boundary, a reference expression [Δθc=15Σ^{-½}] (D. G. Brandon, Acta. Metallurgica. Vol. 14, 1966, p. 1479) suggested by Brandon is used. The case where the deviation between the crystal orientation relationship in the grain boundary and a correct coincidence orientation relationship is small is determined as the coincidence boundary. The deviation is represented by the rotation angle 40 of a rotation matrix, and the rotation angle 40 represents a deviation between a rotation matrix representing the crystal orientation relationship between crystal grains adjacent to the grain boundary and the rotation matrix of the coincidence orientation relationship. The symbol 40c in the above reference expression represents the maximum value of the acceptable deviation angle at which a grain boundary structure as the coincidence boundary can be maintained. The case where the deviation angle from the coincidence orientation relationship having a Σ value of 29 or less is Δθc or less is determined as the coincidence boundary. Σ3 grain boundary 23 is included in high angle grain boundary 21. FIG. 3 also schematically illustrates structure 10 in a cross section of magnetic wire 1, as in FIG. 2. In FIG. 3, high angle grain boundary 21 is illustrated with a bold line, and Σ3 grain boundary 23 is illustrated with a bold dashed line, for easy understanding. In addition, in FIG. 3, a low angle grain boundary 22 is illustrated with a thin line. Low angle grain boundary 22 will be described below.

In structure 10 of magnetic wire 1, each of the area proportion of α phase 11, the average crystal grain size of α phase 11, and the proportion of the length of high angle grain boundary 21 satisfies a specific range. When magnetic wire 1 has specific structure 10 that satisfies all of these three requirements, high output can be obtained and the variation in output is small. Hereinafter, the area proportion of the α phase, the average crystal grain size of the α phase, and the proportion of the length of the high angle grain boundary will be described in detail. In the following description, “the proportion of the length of the high angle grain boundary” is referred to as “the proportion of the high angle grain boundary”.

### <Area Proportion of α Phase>

The area proportion of α phase 11 shown in FIG. 2 is 90% or more. The area proportion of α phase 11 is the proportion of the area of α phase 11 relative to the total area of α phase 11 and γ phase 12. That is, the area proportion of α phase 11 is the proportion of the area of α phase 11 when the sum of the area of α phase 11 and the area of γ phase 12 is taken as 100. The area of γ phase 12 includes 0. When the area of γ phase 12 is 0, the area proportion of α phase 11 is 100%. When the area proportion of α phase 11 is 90% or more, the output characteristics of magnetic wire 1 can be enhanced. From the viewpoint of improving the output characteristics, the area proportion of α phase 11 may be 95% or more, or may further be 98% or more. The upper limit of the area proportion of α phase 11 is, for example, 99.99%. The area proportion of α phase 11 may be 90% or more and 99.99% or less, or may further be 90% or more and 99.98% or less, 95% or more and 99.95% or less, 98% or more and 99.92% or less, or 98.5% or more and 99.90% or less.

The area proportion of α phase 11 is determined by the EBSD method. Specifically, the area proportion of α phase 11 is determined by observing a cross section of magnetic wire 1 with a scanning electron microscope (SEM) and performing crystal analysis by the EBSD method. The cross section to be observed is a transverse section. The transverse section is a cross section orthogonal to the length of magnetic wire 1. The size of the observation field is, for example, 5.0 μm or more×5.0 μm or more. The size of the observation field is appropriately set according to the crystal grain size of α phase 11. For example, the magnification of the SEM is set so that 50 or more, and further, 100 or more crystal grains of α phase 11 may fall within an observation field. The crystal structure of structure 10 in the observation field is analyzed by the EBSD method. Based on the information on the crystal structure obtained by the EBSD method, crystal phases included in structure 10 such as α phase 11 and γ phase 12 are discriminated, and each of the area of α phase 11 and the area of γ phase 12 is measured. The discrimination of crystal phases and the measurement of the area of each phase are performed by using known analysis software. The area proportion of α phase 11 is calculated as {(area of α phase 11)/(area of α phase 11+area of γ phase 12)}×100.

The proportion of the total area of α phase 11 and γ phase 12 relative to the area of structure 10 is 80% or more. That is, the area proportion of the balance that is not detected as α phase 11 or γ phase 12 is 20% or less. The balance other than α phase 11 and γ phase 12 is mainly a region where the above precipitation phase or dislocations in the vicinity of grain boundaries are accumulated. The proportion of the total area of α phase 11 and γ phase 12 may be 85% or more, or may further be 90% or more, 95% or more, 98% or more, 98.5% or more, or 99% or more. The area of the above observation field is considered as the area of structure 10. The proportion of the total area of α phase 11 and γ phase 12 can be calculated as {(area of α phase 11+area of γ phase 12)/(area of observation field)}×100.

### <Average Crystal Grain Size of α Phase>

The average crystal grain size of α phase 11 shown in FIG. 2 is 2.5 μm or less. When the average crystal grain size of α phase 11 is 2.5 μm or less, the output characteristics of magnetic wire 1 can be enhanced. From the viewpoint of improving the output characteristics, the average crystal grain size of α phase 11 may be 2.3 μm or less, or may further be 2.1 μm or less, 1.9 μm or less, 1.6 μm or less, or 1.4 μm or less. The lower limit of the average crystal grain size of α phase 11 is, for example, 0.1 μm. The average crystal grain size of α phase 11 may be 0.1 μm or more and 2.5 μm or less, or may further be 0.2 μm or more and 2.3 μm or less, 0.3 μm or more and 2.1 μm or less, 0.4 μm or more and 1.9 μm or less, 0.6 μm or more and 1.6 μm or less, or 0.7 μm or more and 1.4 μm or less.

The average crystal grain size of α phase 11 is determined by the EBSD method. Specifically, the average crystal grain size of α phase 11 is determined by observing a cross section of magnetic wire 1 with an SEM and performing crystal analysis by the EBSD method. The cross section to be observed is a transverse section. The size of the observation field is, for example, 5.0 μm or more×5.0 μm or more. The size of the observation field is appropriately set according to the crystal grain size of α phase 11. For example, the magnification of the SEM is set so that 50 or more, and further, 100 or more crystal grains of α phase 11 may fall within an observation field. The crystal orientation of structure 10 in the observation field is analyzed by the EBSD method. Based on the information on the crystal orientation obtained by the EBSD method, a grain boundary where the misorientation between adjacent crystal grains is 15° or more is defined as the grain boundary. The crystal grain size of all α phases 11 included in structure 10 is measured. The measurement of the crystal grain size is performed by using known analysis software. The crystal grain size of each α phase 11 is a diameter of a circle having an area equivalent to the area of each α phase 11. The average crystal grain size of α phase 11 is the area weighted average grain size of the crystal grains of all the measured α phases 11.

### <Proportion of High Angle Grain Boundary>

The proportion of high angle grain boundary 21 shown in FIG. 3 is 60% or more. The proportion of high angle grain boundary 21 is the proportion of the length of high angle grain boundary 21 relative to the total length of grain boundaries 20 in structure 10. That is, the proportion of high angle grain boundary 21 is the proportion of the length of high angle grain boundary 21 when the total length of grain boundaries 20 is taken as 100. When the proportion of high angle grain boundary 21 is 60% or more, the output characteristics of magnetic wire 1 can be further enhanced. From the viewpoint of improving the output characteristics, the proportion of high angle grain boundary 21 may be 65% or more, or may further be 70% or more, or 75% or more. The upper limit of the proportion of high angle grain boundary 21 is, for example, 95%. The proportion of high angle grain boundary 21 may be 60% or more and 95% or less, or may further be 65% or more and 90% or less, 70% or more and 88% or less, or 75% or more and 85% or less.

The total length of grain boundaries 20 is the total length of the length of high angle grain boundary 21 and the length of low angle grain boundary 22 when grain boundaries 20 are divided into high angle grain boundary 21 having a misorientation of 15° or more and low angle grain boundary 22 having a misorientation of 2° or more and less than 15°. Grain boundaries having a misorientation of less than 2° are not included in the length of grain boundaries 20.

The proportion of high angle grain boundary 21 is determined by the EBSD method. Specifically, the proportion of high angle grain boundary 21 is determined by observing a cross section of magnetic wire 1 with an SEM and performing crystal analysis by the EBSD method. The cross section to be observed is a transverse section. The size of the observation field is, for example, 5.0 μm or more×5.0 μm or more. The size of the observation field is appropriately set according to the crystal grain size of α phase 11. For example, the magnification of the SEM is set so that 50 or more, and further, 100 or more crystal grains of α phase 11 may fall within an observation field. The crystal orientation of structure 10 in the observation field is analyzed by the EBSD method. Based on the information on the crystal orientation obtained by the EBSD method, all grain boundaries 20 in structure 10 are divided into high angle grain boundary 21 and low angle grain boundary 22. Then, the length of high angle grain boundary 21 and the length of low angle grain boundary 22 are measured. The measurement of the lengths of high angle grain boundary 21 and low angle grain boundary 22 is performed by using known analysis software. The total value of the length of high angle grain boundary 21 and the length of low angle grain boundary 22 is determined as the total length of grain boundaries 20. The proportion of high angle grain boundary 21 is calculated as {(length of high angle grain boundary 21)/(total length of grain boundaries 20)}×100.

In structure 10 of magnetic wire 1, the proportion of the length of Σ3 grain boundary 23 may further satisfy a specific range. When magnetic wire 1 has specific structure 10 in which the proportion of the length of Σ3 grain boundary 23 satisfies a specific range in addition to three requirements described above, further high output can be obtained, and further stable output is easily obtained. Hereinafter, the proportion of the length of Σ3 grain boundary 23 will be described in detail. In the following description, “the proportion of the length of the Σ3 grain boundary” is referred to as “the proportion of the Σ3 grain boundary”.

### <Proportion of Σ3 Grain Boundary>

The proportion of Σ3 grain boundary 23 shown in FIG. 3 may be 5% or more. The proportion of Σ3 grain boundary 23 is the proportion of the length of Σ3 grain boundary 23 relative to the total length of grain boundaries 20 in structure 10. When the proportion of Σ3 grain boundary 23 is 5% or more, the output characteristics of magnetic wire 1 can be further enhanced. From the viewpoint of improving the output characteristics, the proportion of Σ3 grain boundary 23 may be 6% or more, or may further be 8% or more. The upper limit of the proportion of Σ3 grain boundary 23 is, for example, 25%. The proportion of Σ3 grain boundary 23 may be 5% or more and 25% or less, or may further be 6% or more and 22% or less, or 8% or more and 20% or less.

The proportion of Σ3 grain boundary 23 is determined by the EBSD method from a transverse section of magnetic wire 1, as in the proportion of the high angle grain boundary described above. Based on the information on the crystal orientation obtained by the EBSD method, only Σ3 grain boundary 23 is separated from all grain boundaries 20 in structure 10 in the observation field, and the length of Σ3 grain boundary 23 is measured. The separation of Σ3 grain boundary 23 and the measurement of the length of Σ3 grain boundary 23 are performed by using known analysis software. The proportion of Σ3 grain boundary 23 is calculated as {(length of Σ3 grain boundary 23)/(total length of grain boundaries 20)}×100.

In structure 10 of magnetic wire 1, the KAM value of α phase 11 may satisfy a specific range. When magnetic wire 1 has specific structure 10 in which the KAM value of α phase 11 satisfies a specific range in addition to three requirements described above, further high output can be obtained, and further stable output is easily obtained. Hereinafter, the KAM value of α phase 11 will be described in detail.

### <KAM Value of α Phase>

The KAM value of α phase 11 may be 0.45° or more. When the KAM value of α phase 11 is 0.45° or more, the output characteristics of magnetic wire 1 can be enhanced. From the viewpoint of improving the output characteristics, the KAM value of α phase 11 may be 0.47° or more, or may further be 0.48° or more, or 0.50° or more. The upper limit of the KAM value of α phase 11 is, for example, 1.0°. The KAM value of α phase may be 0.45° or more and 1.0° or less, or may further be 0.47° or more and 0.8° or less, 0.48° or more and 0.75° or less, or 0.50° or more and 0.70° or less.

The KAM value of α phase 11 is determined by the EBSD method. Specifically, the KAM value of α phase 11 is determined by observing a cross section of magnetic wire 1 with an SEM and performing crystal analysis by the EBSD method. The cross section to be observed is a transverse section. The size of the observation field is, for example, 5.0 μm or more×5.0 μm or more. The crystal orientation of structure 10 in the observation field is analyzed by the EBSD method. With respect to electron beam irradiation spots arranged in a designated step size, all the misorientations between adjacent spots are measured by the EBSD method. The step size is, for example, 0.05 μm intervals. By extracting and averaging measurement values whose misorientations are less than 5°, the KAM value of each electron beam irradiation spot is calculated. The average value of the KAM values of the electron beam irradiation spots that are determined as α phase 11 in the observation field is determined as the KAM value of α phase 11. Based on the information on the crystal orientation obtained by the EBSD method, the KAM value of α phase 11 included in structure 10 is calculated. The calculation of the KAM value is performed by using known analysis software. The above KAM value correlates with the amount of strain accumulation. It is presumed that the higher the KAM value is, the larger the orientation change due to strain in crystal grains.

### (Shape)

The shape of magnetic wire 1 can be appropriately selected. Magnetic wire 1 shown in FIG. 1 is a round wire. The shape of the transverse section of magnetic wire 1 is a circular shape. The shape of the transverse section of magnetic wire 1 may be a non-circular shape. The non-circular shape is, for example, a polygonal shape, a flattened shape, or an oval shape. The polygonal shape is, for example, a quadrangle or a hexagon. The quadrangle includes a rectangle, a square, a trapezoid, and a rhombus. The oval shape as used herein includes an elliptical shape. The elliptical shape is a so-called race track shape, and is a shape consisting of two lines parallel to each other and two semicircles that connect both ends of two lines. The lengths of two lines are equivalent to each other. The lengths of two semicircles are equivalent to each other. The flattened shape as used herein refers to shapes flatter than a true circle in a broad sense. The flattened shape includes the rectangular shape and the oval shape.

### (Size)

### <Diameter>

A diameter D of magnetic wire 1 can be appropriately selected. Diameter D of magnetic wire 1 as used herein is a diameter of a circle having an area equivalent to the area of the transverse section of magnetic wire 1. Diameter D of magnetic wire 1 is, for example, 0.1 mm or more and 1.0 mm or less. Magnetic wire 1 having diameter D within the above range can suitably be used for the core of a magnetic sensor and the like. Diameter D of magnetic wire 1 may be 0.15 mm or more and 0.8 mm or less, or may further be 0.2 mm or more and 0.6 mm or less.

### <Cross-Sectional Area>

The cross-sectional area of magnetic wire 1 can be appropriately selected. The cross-sectional area of magnetic wire 1 is the area of the transverse section of magnetic wire 1. The cross-sectional area of magnetic wire 1 is, for example, 0.007 mm² or more and 0.8 mm² or less. Magnetic wire 1 having a cross-sectional area within the above range can suitably be used for the core of a magnetic sensor and the like. The cross-sectional area of magnetic wire 1 may be 0.017 mm² or more and 0.51 mm² or less, or may further be 0.03 mm² or more and 0.3 mm² or less.

### <Length>

A length L of magnetic wire 1 can be appropriately selected. Length L of magnetic wire 1 is the length from the first end to the second end of magnetic wire 1. Length L of magnetic wire 1 is, for example, 3 mm or more and 25 mm or less. Magnetic wire 1 having length L within the above range can suitably be used for the core of a magnetic sensor and the like. Length L of magnetic wire 1 may be 4 mm or more and 20 mm or less, or may further be 5 mm or more and 15 mm or less.

The smaller diameter D or length L of magnetic wire 1, the more the volume of magnetic wire 1 is reduced, so that the output characteristics of magnetic wire 1 are reduced. In magnetic wire 1 of an embodiment, high output can be obtained and the variation in output is small, so that sufficient output characteristics are easily secured even with small diameter D or length L. When magnetic wire 1 having diameter D and length L within the above range is used for the core of a magnetic sensor, miniaturization of the magnetic sensor can be achieved.

### [Method for Manufacturing Magnetic Wire]

Magnetic wire 1 of an embodiment can be manufactured by a method for manufacturing a magnetic wire according to an embodiment. The method for manufacturing a magnetic wire of an embodiment comprises the following first step, second step, and third step.

The first step is a step of drawing a material to obtain a drawn wire.

The second step is a step of subjecting the drawn wire to first heat treatment to obtain a first heat treated material.

The third step is a step of twisting the first heat treated material.

Hereinafter, each step will be described in detail.

### (First Step)

In the first step, a drawn wire is produced by drawing a material. The material is made of an alloy containing iron and cobalt as main components. The composition of the alloy that constitutes the material is the composition described in the item of the composition of the magnetic wire described above. The composition of the material is the same as the composition of the magnetic wire to be manufactured. The melting point of the material is higher than the temperature of the first heat treatment. The melting point of the material is, for example, about 1300° C. The material is, for example, a cast material or an extrusion material. The cast material includes a continuously cast material and a continuously cast and rolled material. The material may be a continuously cast material. The continuously cast and rolled material has a small variation in the structure and has high productivity. Drawing is a method for processing a material into a wire with a hole die or a roller die. Drawing includes, in addition to usual drawing in which a material is passed through the hole of a hole die, drawing with a roller die and drawing with Turks heads. When cold drawing is performed, a drawn wire having high dimensional accuracy is easily obtained.

In the drawing, a material is processed into a drawn wire having a predetermined shape so that the diameter of the drawn wire is a predetermined diameter. The shape of the transverse section of the drawn wire is the same as the shape of the transverse section of the magnetic wire to be manufactured. The diameter of the drawn wire is the same as the diameter of the magnetic wire to be manufactured. Drawing may be performed a plurality of times until the diameter of the drawn wire reaches a predetermined diameter. When drawing is performed a plurality of times, heat treatment may be performed during drawing. This heat treatment is mainly intended to soften the wire during drawing to improve processability. This heat treatment is referred to as the intermediate heat treatment. The temperature of the intermediate heat treatment is, for example, 750° C. or more and 1100° C. or less. The higher the temperature of the intermediate heat treatment, the more easily the processability is improved. The temperature of the intermediate heat treatment may be 780° C. or more and 900° C. or less, or may further be 780° C. or more and 850° C. or less. The time of the intermediate heat treatment is, for example, 10 minutes or more and 720 minutes or less. The intermediate heat treatment may be performed in a hydrogen atmosphere. After the intermediate heat treatment is performed, the wire is cooled. The cooling rate after the intermediate heat treatment is, for example, 1° C./seconds or more. The cooling rate may further be 5° C./seconds or more, or may be, in particular, 10° C./seconds or more. The higher the cooling rate, the more easily the processability of the wire is improved. When the cooling rate is too low, the processability of the wire deteriorates due to the occurrence of order transformation.

The first step may comprise a step of drawing the material at a rate of work of 10% or more, when the material is processed into a drawn wire. The rate of work refers to, when the above intermediate heat treatment is performed, the rate of work after the final intermediate heat treatment and until the final drawing. The rate of work when the above intermediate heat treatment is performed is the proportion obtained by dividing the difference between the cross-sectional area of the wire at a stage where the final intermediate heat treatment is performed and the cross-sectional area of the drawn wire after final drawing by the cross-sectional area of the wire at a stage where the final intermediate heat treatment is performed. For example, the case where drawing is performed 5 times will be considered. Assuming that intermediate heat treatment is performed between the second drawing and the third drawing, and between the third drawing and the fourth drawing. No intermediate heat treatment is performed after the fourth drawing. In this example, the intermediate heat treatment performed between the third drawing and the fourth drawing is the final intermediate heat treatment. In this case, drawing is performed so that the rate of work from the diameter of the wire after the third drawing to the diameter of the wire after the fifth drawing is 10% or more. When the above intermediate heat treatment is not conducted, the above rate of work is the same as the total rate of work from the beginning until the completion of drawing. The total rate of work is a proportion obtained by dividing the difference between the cross-sectional area of the material before drawing and the cross-sectional area of the drawn wire after final drawing by the cross-sectional area of the material before drawing. When the above rate of work is 10% or more, the structure of the drawn wire is easily controlled to be a predetermined structure. Specifically, a structure in which the average crystal grain size of the α phase is small and the KAM value of the α phase is high can be easily obtained. As a result, the structure of the magnetic wire finally manufactured easily becomes the structure described in the item of the structure of the magnetic wire described above. The above rate of work may be 30% or more, or may further be 40% or more. The upper limit of the above rate of work is, although it depends on the diameter of the material or the diameter of the drawn wire to be produced, for example, 99.99%. The above rate of work may be 10% or more and 99.99% or less, or may further be 30% or more and 99.9% or less, or 40% or more and 99.5% or less.

### (Second Step)

In the second step, the drawn wire is subjected to first heat treatment to produce a first heat treated material. After the first heat treatment is performed, the first heat treated material is cooled to room temperature. The room temperature is 20° C.±15° C. The first heat treatment is performed under such conditions that the structure of the alloy of the first heat treated material includes the α phase and the γ phase and the proportion of the area of the α phase relative to the total area of the α phase and the γ phase in the cross section of the first heat treated material is 90% or more. The first heat treatment may be performed in a hydrogen atmosphere. By the first heat treatment, the structure of the first heat treated material is controlled to have the above-described specific structure in which the α phase and the γ phase coexist. This enables a magnetic wire having the structure described in the item of the structure of the magnetic wire described above to be obtained.

As for the conditions to obtain the above specific structure, for example, the temperature of the first heat treatment is preferably set to a specific range. In the first heat treatment, typically, the drawn wire may be subjected to heat treatment at a temperature of more than 750° C. and 850° C. or less. When the temperature of the first heat treatment is too low, it is difficult to twist the first heat treated material in the third step. When the temperature of the first heat treatment is low, the area proportion of the α phase decreases, the KAM value of the α phase decreases, and the average crystal grain size of the α phase increases. In addition, when the temperature of the first heat treatment is low, the high angle grain boundary or the Σ3 grain boundary is not sufficiently formed, the proportion of the high angle grain boundary decreases, and the proportion of the Σ3 grain boundary decreases. When the temperature of the first heat treatment is too high, crystal grains in the previous γ phase before martensitic transformation are coarsened. As a result, the average crystal grain size of the α phase produced after cooling increases.

The optimal temperature range of the first heat treatment varies depending on the composition of the alloy. For example, in the case of a composition containing 40% by mass or more and 70% by mass or less, in particular, 45% by mass or more and 55% by mass or less of Co, the temperature of the first heat treatment may be 760° C. or more and 840° C. or less, 780° C. or more and 820° C. or less, or may further be 790° C. or more and 810° C. or less. The time of the first heat treatment is, for example, 10 minutes or more and 720 minutes or less.

The cooling rate after the first heat treatment is, for example, 1° C./seconds or more. The cooling rate may further be 5° C./seconds or more, or may in particular be 10° C./seconds or more. The higher the cooling rate, the more the area proportion of the α phase increases due to the occurrence of martensitic transformation. Thus, the above specific structure is easily obtained. When the cooling rate is too low, the processability of the first heat treated material may deteriorate due to the occurrence of order transformation. When the cooling rate is too low, martensitic transformation does not sufficiently occur and the area proportion of the α phase decreases.

### (Third Step)

In the third step, the first heat treated material is twisted. Twisting refers to twisting using the axis of the first heat treated material as a rotation axis. Before twisting is performed, the first heat treated material is preferably cut into an appropriate length. By twisting the first heat treated material, a magnetic wire having high output characteristics can be obtained. Strain induced transformation occurs by twisting. Thus, the γ phase in the structure of the first heat treated material transforms to the α phase, so that the α phase increases in the structure of the twisted first heat treated material. Twisting may be performed by cold twisting. After twisting is performed, the twisted first heat treated material is cut into a predetermined length. The predetermined length is the same as the length of the magnetic wire to be manufactured.

Twisting may be performed under such conditions that the amount of strain on the surface of the twisted first heat treated material is 1.0 or more and 4.5 or less. The surface of the first heat treated material as used herein refers to the outer peripheral surface of the first heat treated material. By performing twisting so that the above amount of strain is 1.0 or more and 4.5 or less, a magnetic wire having high output characteristics can be stably manufactured. The above amount of strain may be 1.5 or more and 4.0 or less.

With reference to FIG. 1, the method for determining the amount of strain will be described. Herein, magnetic wire 1 shown in FIG. 1 is considered as the above first heat treated material. In the following description, the first heat treated material is referred to as the “wire”. The amount of strain 8 is expressed by the following expression.

δ=rθ/L

r denotes the radius (mm) of the wire. That is, r=D/2. θ denotes a twisting angle (rad). When the wire is twisted once, θ=2π. L denotes the length (mm) of the wire.

The amount of strain is determined by the sum of the number of rotations, in addition to the radius of the wire and the length of the wire. Specific examples of the method for determining the amount of strain will be described. In this description, radius r of the wire=0.15 mm and length L of the wire=30 mm. The amount of strain when twisting is performed under conditions where the wire is rotated 30 times in clockwise direction and then rotated 30 times in counterclockwise direction is about 1.8, since δ=(30+30)×{0.15×2π/30}=60×0.01π. The amount of strain when twisting is performed 15 times in clockwise direction, 30 times in counterclockwise direction, and 15 times in clockwise direction, in the order presented, is about 1.8, since δ=(15+30+15)×{0.15×2π/30}=60×0.01π. In these two conditions, the total number of rotations by twisting is the same, and the total number of clockwise rotations is the same as the total number of counterclockwise rotations.

The conditions of twisting can be appropriately changed. For example, the operation in which twisting is performed a times in clockwise direction and b times in counterclockwise direction is determined as one set, and this set may be repeated a plurality of times. Alternatively, the operation in which twisting is performed c times in clockwise direction, d times in counterclockwise direction, and e times in clockwise direction, in the order presented, is determined as one set, and this set may be repeated a plurality of times. In addition, the total number of clockwise rotations and the total number of counterclockwise rotations may be different from each other.

### (Other Steps)

The method for manufacturing a magnetic wire of an embodiment may comprise a step of subjecting the first heat treated material after being twisted to the second heat treatment after the above third step of twisting, or may comprise a step of subjecting the first heat treated material during being twisted to the second heat treatment simultaneous with the above step of twisting. When the second heat treatment is performed simultaneous with twisting, twisting may be completed in a state where the first heat treated material is twisted, and while maintaining the state where the first heat treated material is twisted, the second heat treatment may be performed. For example, while gripping both ends of the wire with chucks, twisting is performed by rotating either one chuck. Performing the second heat treatment simultaneous with twisting includes not only the case where the second heat treatment is performed while twisting the wire, but also, even after the last twist is applied to the wire, the case where the second heat treatment is performed while gripping the wire with chucks in a state where the twist stress is acted on the wire.

In the second heat treatment, the first heat treated material after being twisted or the first heat treated material during being twisted is subjected to heat treatment at a temperature of, for example, 150° C. or more and 400° C. or less. Since the non-uniformly introduced strain becomes uniform by setting the temperature of the second heat treatment to the above specific range, the output characteristics of the manufactured magnetic wire can be enhanced. When the temperature of the second heat treatment is too high, the average crystal grain size of the α phase increases and the area proportion of the α phase decreases along with the increase of the γ phase. As a result, the reduction in the output characteristics of the magnetic wire may be caused. The temperature of the second heat treatment may be 250° C. or more and 375° C. or less, or may further be 300° C. or more and 350° C. or less. The time of the second heat treatment is, for example, 10 minutes or more and 720 minutes or less.

Magnetic wire 1 of an embodiment having specific structure 10 is excellent in output characteristics. Specifically, since magnetic wire 1 has structure 10 in which each of the area proportion of α phase 11, the average crystal grain size of α phase 11, and the proportion of high angle grain boundary 21 satisfies a specific range, high output can be obtained and the variation in output is small. Further, since magnetic wire 1 has structure 10 in which at least one of the proportion of Σ3 grain boundary 23 and the KAM value of α phase 11 satisfies a specific range in addition to these three requirements, further high output is obtained.

In the method for manufacturing a magnetic wire of an embodiment, a magnetic wire having high output characteristics can be obtained by performing the first heat treatment so as to have a specific structure in which the α phase and the γ phase coexist, and then twisting the first heat treated material.

[Composite magnetic wire]

### Summary

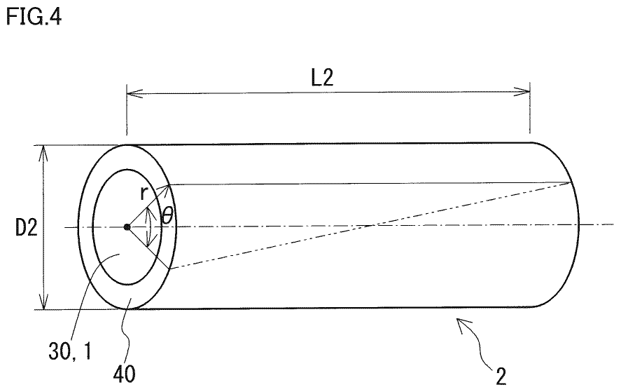

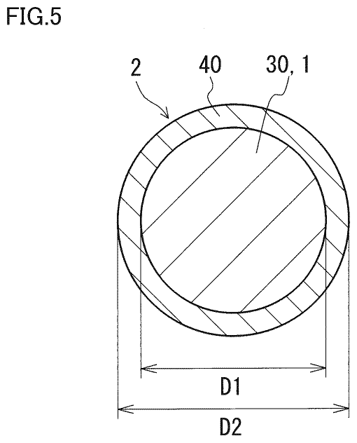

With reference to FIG. 4 to FIG. 6, a composite magnetic wire 2 according to an embodiment will be described. Composite magnetic wire 2 includes a core material 30 and a coating material 40 as shown in FIG. 4 and FIG. 5. Coating material 40 covers the outer peripheral surface of core material 30. The outer peripheral surface of core material 30 and the inner peripheral surface of coating material 40 are in direct contact with each other. FIG. 5 shows a transverse section of composite magnetic wire 2. The transverse section is a cross section orthogonal to the length of composite magnetic wire 2.

### (Core Material)

Core material 30 is made of magnetic wire 1 of the embodiment described above. In core material 30, a large Barkhausen jump phenomenon appears when an external magnetic field is applied. Core material 30 is made of an alloy containing Fe and Co as main components. Core material 30 has the same composition as the composition of the alloy constituting magnetic wire 1 described above. The composition of core material 30 is as described in the item of the composition of the magnetic wire described above. The melting point of core material 30 is, for example, about 1300° C.

Core material 30 has the same structure as the structure of the alloy that constitutes magnetic wire 1 described above. In the structure of core material 30, each of the area proportion of the α phase, the average crystal grain size of the α phase, and the proportion of the high angle grain boundary satisfies a specific range. Core material 30 has a specific structure that satisfies all of these three requirements. Core material 30 having a specific structure is excellent in output characteristics. In composite magnetic wire 2 having such core material 30, high output can be obtained and the variation in output is small. In core material 30, the proportion of the 23 grain boundary may satisfy a specific range. In core material 30, the KAM value of α phase may satisfy a specific range. When core material 30 has a structure in which at least one of the proportion of the Σ3 grain boundary and the KAM value of α phase satisfies a specific range in addition to the above three requirements, composite magnetic wire 2 can obtain further high output. The specific range of each of the area proportion of the α phase, the average crystal grain size of the α phase, the proportion of the high angle grain boundary, the proportion of the Σ3 grain boundary, and the KAM value of α phase is as described in the item of the structure of the magnetic wire described above.

### (Coating Material)

Coating material 40 is made of metal. The metal that constitutes coating material 40 is, for example, any of iron or an iron alloy, copper or a copper alloy, aluminum or an aluminum alloy, and nickel or a nickel alloy. The iron alloy is, for example, stainless steel or carbon steel. Stainless steel is, for example, SUS403, SUS430, SUS304, SUS316, SUS304L, or SUS316L. The copper alloy is, for example, phosphor bronze. The nickel alloy is, for example, permalloy, nitinol, or nichrome. Coating material 40 may be a magnetic material or a non-magnetic material. Metal has a moderate elongation. When the material of coating material 40 is metal, twisting is easily performed in the manufacturing process. When the material of coating material 40 is metal, the output characteristics of core material 30 are easily improved by twisting. As a result, high output is easily obtained in composite magnetic wire 2. The material of coating material 40 can be specified by, for example, the analysis results of the composition of coating material 40 by the EDX method.

The reason why the output characteristics of core material 30 are improved by providing coating material 40 on core material 30 is considered as follows. When composite magnetic wire 2 is twisted, core material 30 is pulled by coating material 40 in the vicinity of the outer peripheral surface of core material 30, and core material 30 is stretched along the length of core material 30. Tensile residual stress along the length of core material 30 is introduced to core material 30 by twisting. As a result, the tensile residual stress increases, and the uniaxial anisotropy of core material 30 increases. Since the uniaxial anisotropy of core material 30 increases, the output characteristics of core material 30 are improved.

In the present embodiment, core material 30 is cladded with coating material 40. The term “core material 30 is cladded with coating material 40” means that they are joined together in a state where tubular coating material 40 is fitted on the outer peripheral surface of core material 30. Coating material 40 may be plated on the outer peripheral surface of core material 30.

### <Vickers Hardness>

The Vickers hardness of coating material 40 is, for example, 200 HV or more. The higher the hardness of coating material 40, the more easily tensile residual stress is introduced to core material 30 by twisting. As a result, the output characteristics of core material 30 are easily improved. When the Vickers hardness of coating material 40 is 200 HV or more, tensile residual stress is effectively and easily imparted to core material 30. The Vickers hardness of coating material 40 is 300 HV or more, or may further be 380 HV or more. The upper limit of the Vickers hardness of coating material 40 is, for example, 700 HV. The Vickers hardness of coating material 40 may be 200 HV or more and 700 HV or less, or may further be 300 HV or more and 600 HV or less, or 380 HV or more and 480 HV or less.

### <Method for Measuring Vickers Hardness>

The Vickers hardness of coating material 40 is determined as follows. A transverse section of composite magnetic wire 2 is taken. Specifically, after composite magnetic wire 2 is embedded in a resin, composite magnetic wire 2 is cut in a plane orthogonal to the length of composite magnetic wire 2. The exposed transverse section of composite magnetic wire 2 is polished. In the transverse section of composite magnetic wire 2, midpoints of the thickness of coating material 40 are determined. A midpoint of the thickness of coating material 40 is a midpoint between the inner periphery and the outer periphery of coating material 40. As shown in FIG. 5, when the shape of the transverse section of coating material 40 is cylindrical, midpoints of the thickness of coating material 40 are positioned on the circumference of a concentric circle having a diameter obtained by adding the internal diameter of coating material 40 to the outer diameter thereof and dividing the result by two. The internal diameter of coating material 40 is equivalent to diameter D1 of core material 30, and the outer diameter of coating material 40 is equivalent to diameter D2 of composite magnetic wire 2. That is, the diameter of the concentric circle is (D1+D2)/2. Micro Vickers hardness test is performed on four points among the above midpoints of the thickness. The average value of the measured Vickers hardnesses at four points is considered as the Vickers hardness of coating material 40. Four points are determined so that they are arranged at equal intervals around the central axis of coating material 40. The method for the micro Vickers hardness test is performed in accordance with JIS Z 2244:2009 “Vickers hardness test”. The test force is 0.098 N (0.01 kgf).

Herein, the Vickers hardness of core material 30 is, for example, about 400 HV to about 500 HV. The Vickers hardness of core material 30 is determined as follows. In the transverse section of composite magnetic wire 2, midpoints of the radius of core material 30 are determined. A midpoint of the radius of core material 30 is a midpoint between the center of core material 30 and a point on the outer periphery of core material 30. As shown in FIG. 5, the shape of the transverse section of core material 30 is a circular shape, midpoints of the radius of core material 30 are positioned on the circumference of a concentric circle having a diameter that is ½ of the diameter of core material 30. That is, the diameter of the concentric circle is D1/2. Micro Vickers hardness test is performed on four points among the above midpoints of the diameter. The average value of the measured Vickers hardnesses at four points is considered as the Vickers hardness of core material 30. Four points are determined so that they are arranged at equal intervals around the central axis of core material 30.

### <Melting Point>

The melting point of coating material 40 is, for example, more than 850° C. When the melting point of coating material 40 is more than 850° C., the first heat treatment described below can be performed in the manufacturing process in a state where core material 30 is coated with coating material 40. The melting point of coating material 40 may be 900° C. or more, or may further be 950° C. or more.

### <Method for Measuring Melting Point>

The melting point of coating material 40 is determined as follows. The initial shape of composite magnetic wire 2 is measured. For example, the diameter of composite magnetic wire 2 is measured. Composite magnetic wire 2 is heated, and then subjected to cooling treatment. The heating temperature at which coating material 40 is melted and changes its shape is determined as the melting point of coating material 40. The specific method for measuring the melting point is as follows. Composite magnetic wire 2 is heated to a predetermined temperature, and then cooled. By comparing the shape of composite magnetic wire 2 after cooling with the initial shape, whether coating material 40 is melted or not is confirmed. When coating material 40 is not melted, composite magnetic wire 2 is heated to a higher temperature, and then cooled. After cooling, whether coating material 40 is melted or not is confirmed. This operation is repeated until coating material 40 is melted, thereby determining a heating temperature at which coating material 40 is melted. The heating temperature is set, for example, in increments of 50° C. from 100° C. to 1300° C. The time for holding composite magnetic wire 2 in a heated state is, for example, 5 minutes or more.

### (Shape)

The shape of composite magnetic wire 2 can be appropriately selected. Composite magnetic wire 2 shown in FIG. 4 and FIG. 5 is a round wire. The shape of the transverse section of composite magnetic wire 2 is a circular shape. The shape of the transverse section of composite magnetic wire 2 may be a non-circular shape. The non-circular shape is, for example, a polygonal shape, a flattened shape, or an oval shape. The polygonal shape is, for example, a quadrangle or a hexagon. The quadrangle includes a rectangle, a square, a trapezoid, and a rhombus. The oval shape includes an elliptical shape. The flattened shape refers to flat shapes in a broad sense. The flattened shape includes the rectangular shape and the oval shape. The shape of the transverse section of core material 30 shown in FIG. 4 and FIG. 5 is a circular shape. The shape of the transverse section of coating material 40 is a cylindrical shape.

### (Size)

### <Diameter>

The diameter D2 of composite magnetic wire 2 can be appropriately selected. Diameter D2 of composite magnetic wire 2 herein is a diameter of a circle having an area equivalent to the area of the transverse section of composite magnetic wire 2. Diameter D2 of composite magnetic wire 2 is, for example, 0.105 mm or more and 3.0 mm or less. Composite magnetic wire 2 having diameter D2 within the above range can suitably be used for the core of a magnetic sensor and the like. Diameter D2 of composite magnetic wire 2 may be 0.11 mm or more and 2.0 mm or less, 0.12 mm or more and 1.0 mm or less, 0.15 mm or more and 0.8 mm or less, or may further be 0.2 mm or more and 0.6 mm or less.

### <Length>

Length L2 of composite magnetic wire 2 can be appropriately selected. Length L2 of composite magnetic wire 2 is the length from the first end to the second end of composite magnetic wire 2. Length L2 of composite magnetic wire 2 is, for example, 3 mm or more and 25 mm or less. Composite magnetic wire 2 having length L2 within the above range can suitably be used for the core of a magnetic sensor and the like. Length L2 of composite magnetic wire 2 may be 4 mm or more and 20 mm or less, or may further be 5 mm or more and 15 mm or less.

The smaller diameter D2 or length L2 of composite magnetic wire 2, the more the volume of core material 30 is reduced, so that the output characteristics of composite magnetic wire 2 are reduced. In composite magnetic wire 2 of an embodiment, high output can be obtained and the variation in output is small, so that sufficient output characteristics are easily secured even with small diameter D2 or length L2. When composite magnetic wire 2 having diameter D2 and length L2 within the above range is used for the core of a magnetic sensor, miniaturization of the magnetic sensor can be achieved.

### (Proportion of Diameter of Core Material Relative to Diameter of Composite Magnetic Wire)

The proportion of diameter D1 of core material 30 relative to diameter D2 of composite magnetic wire 2 shown in FIG. 5 may be 45% or more and 95% or less. In the following description, “the proportion of the diameter of the core material relative to the diameter of the composite magnetic wire” is referred to as “the ratio of the core material”. Diameter D1 of core material 30 is a diameter of a circle having an area equivalent to the area of the transverse section of core material 30. The ratio of core material 30 is the proportion obtained by dividing diameter D1 of core material 30 by diameter D2 of composite magnetic wire 2. When the ratio of core material 30 is 45% or more, the area proportion of core material 30 occupied in the transverse section of composite magnetic wire 2 can be ensured. By ensuring a certain degree of the area proportion of core material 30, the output characteristics of composite magnetic wire 2 can be enhanced. When the ratio of core material 30 is 95% or less, the area proportion of coating material 40 occupied in the transverse section of composite magnetic wire 2 can be ensured. By ensuring a certain degree of the area proportion of coating material 40, tensile residual stress is easily introduced to core material 30 by twisting. Since the tensile residual stress is easily introduced to core material 30, the uniaxial anisotropy of core material 30 is easily enhanced. As a result of the improvement of the output characteristics of core material 30, the output characteristics of composite magnetic wire 2 can be enhanced. The ratio of core material 30 may be 48% or more and 95% or less, 55% or more and 90% or less, or may further be 60% or more and 85% or less.

Diameter D1 of core material 30 is, for example, 0.1 mm or more and 1.0 mm or less. In composite magnetic wire 2 having diameter D1 of core material 30 within the above range, high output is easily obtained. Diameter D1 of core material 30 may be 0.15 mm or more and 0.8 mm or less, or may further be 0.2 mm or more and 0.6 mm or less.

### (Twist Mark)

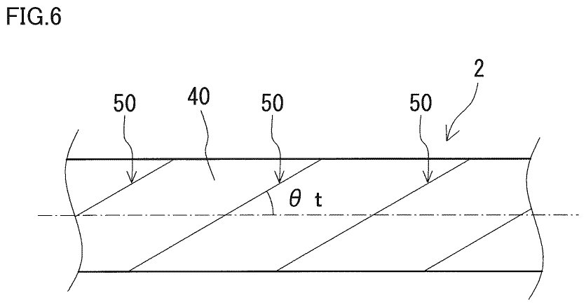

Composite magnetic wire 2 may have a twist mark 50 on the outer peripheral surface of coating material 40, as shown in FIG. 6. There is a case where twist mark 50 is present on the outer peripheral surface of coating material 40 of twisted composite magnetic wire 2. Twist mark 50 is formed in the manufacturing process by performing twisting in a state where core material 30 is coated with coating material 40.

In the manufacturing process of composite magnetic wire 2, although the detail will be described below, there is a case where a wire in which the outer peripheral surface of a core material is coated with a coating material is drawn before twisting. On the surface of the drawn wire, that is, on the outer peripheral surface of the coating material, a plurality of drawn wire marks is formed. The drawn wire mark is a thin streaky mark extending linearly along the length of the wire. The drawn wire mark is generated by being rubbed with a die or the like during drawing. The drawn wire mark is formed over the total length of the wire. When this wire is twisted, the drawn wire mark is deformed to form twist mark 50. Also in the case where no drawn wire marks are present on the surface of the drawn wire, the surface of the wire may be deformed to form twist mark 50 by twisting the wire. When the twisted wire remains in a twisted state, as shown in FIG. 6, twist mark 50 is inclined to the axis of composite magnetic wire 2. The term in a twisted state refers that twisting is completed in a state where the wire is twisted. Composite magnetic wire 2 in a twisted state can be obtained by rotating the wire only in one direction during twisting. Alternatively, when the wire is rotated in clockwise and counterclockwise direction during twisting, composite magnetic wire 2 in a twisted state can be obtained by setting so that the total number of clockwise rotations and the total number of counterclockwise rotations may be different from each other.

### <Angle of Twist Mark>

When an angle θt of twist mark 50 is more than 0°, composite magnetic wire 2 is in a twisted state. In composite magnetic wire 2 in a twisted state, the tensile residual stress introduced to core material 30 (see FIG. 4) by twisting is easily maintained. As a result, the output characteristics of core material 30 are easily improved. Angle θt of twist mark 50 may be 4° or more and 60° or less. When angle θt of twist mark 50 is 4° or more and 60° or less, the tensile residual stress is easily uniformly introduced over the total length of core material 30 shown in FIG. 4, so that the output characteristics of core material 30 are easily improved. The angle of the twist mark may be 5° or more and 55° or less, or may further be 20° or more and 40° or less.

Angle θt of twist mark 50 can be determined as follows. The surface of composite magnetic wire 2, that is, the outer peripheral surface of coating material 40 is observed with an optical microscope. The tilt angle of twist mark 50 relative to the axis line of composite magnetic wire 2 is measured. The tilt angles of 20 or more twist marks 50 are measured, and the average value thereof is determined as angle θt of twist mark 50.

### [Method for Manufacturing Composite Magnetic Wire]

Composite magnetic wire 2 of an embodiment can be manufactured by a method for manufacturing a composite magnetic wire according to an embodiment. The method for manufacturing a composite magnetic wire of an embodiment includes the following first step, second step, third step, and fourth step.

The first step is a step of coating the outer peripheral surface of a core material with a coating material to obtain a coated wire.

The second step is a step of drawing the coated wire to obtain a drawn wire.

The third step is a step of subjecting the drawn wire to first heat treatment to obtain a first heat treated material.

The fourth step is a step of twisting the first heat treated material.

In the method for manufacturing a composite magnetic wire according to an embodiment, the steps proceed [coating], [wire drawing], [first heat treatment], and [twisting] in the order presented. Hereinafter, each step will be described in detail.

### (First Step)

In the first step, the outer peripheral surface of a core material is coated with a coating material to produce a coated wire. The core material is made of an alloy containing iron and cobalt as main components. For example, a cast material or an extrusion material can be utilized as the core material. The coating material is made of metal. The coating material can be formed on the outer peripheral surface of the core material by, for example, a cladding method or a plating method. The cladding method is a method for joining a coating material on the outer peripheral surface of a core material by drawing a tubular coating material, with the core material inserted therein. The thickness of the coating material can be appropriately selected so that the ratio of the core material may be the above-described specific range in a composite magnetic wire to be manufactured. Specifically, the thickness of the coating material is preferably selected so that the ratio of the core material in the finally produced composite magnetic wire may be 45% or more and 95% or less. The melting point of the core material and the melting point of the coating material are higher than the temperature of the first heat treatment. The melting point of the core material and the melting point of the coating material are, for example, more than 850° C. The melting point of the core material and the melting point of the coating material may be different from each other or the same.

### (Second Step)

In the second step, a drawn wire is produced by drawing a coated wire. The second step is the same as the first step in the above-described method for manufacturing a magnetic wire. The second step in the method for manufacturing a composite magnetic wire is different from the first step in the above-described method for manufacturing a magnetic wire, in terms of drawing the coated wire. Drawing is the same as drawing described in the above-described method for manufacturing a magnetic wire, and thus the detailed description is omitted.

### (Third Step)

In the third step, the drawn wire is subjected to first heat treatment to produce a first heat treated material. The third step is the same as the second step in the above-described method for manufacturing a magnetic wire. The first heat treatment is the same as the first heat treatment described in the above-described method for manufacturing a magnetic wire, and thus the detailed description is omitted.

### (Fourth Step)

In the fourth step, the first heat treated material is twisted. The third step is the same as the third step in the above-described method for manufacturing a magnetic wire. However, the amount of strain by twisting in the method for manufacturing a composite magnetic wire is different from the amount of strain by twisting in the above-described method for manufacturing a magnetic wire. In the method for manufacturing a composite magnetic wire, twisting may be performed under such conditions that the amount of strain on the surface of the twisted first heat treated material is 0.8 or more and 3.0 or less. By performing twisting so that the above amount of strain is 0.8 or more and 3.0 or less, a composite magnetic wire having high output characteristics can be stably manufactured. The above amount of strain may be 1.0 or more and 2.0 or less.

The method for determining the amount of strain in the case of the composite magnetic wire will be described with reference to FIG. 4. Herein, composite magnetic wire 2 shown in FIG. 4 is considered as the above first heat treated material. In the following description, the first heat treated material is referred to as “the wire”. The amount of strain δ is represented by the following expression.

δ=rθ/L

r denotes the radius (mm) of the wire. That is, r=D2/2. θ denotes a twisting angle (rad). When the wire is twisted once, θ=2π. L denotes the length (mm) of the wire. That is, L=L2.

The method for determining the amount of strain of the composite magnetic wire is different from the method for determining the amount of strain described in the above-described method for manufacturing a magnetic wire, in terms of determining the amount of strain using the diameter of the wire including the coating material. Otherwise, twisting is the same as twisting described in the above-described method for manufacturing a magnetic wire, and thus the detailed description is omitted.

Herein, when the first heat treated material is twisted, the completion of twisting in a state where the first heat treated material is twisted allows a composite magnetic wire in a twisted state to be manufactured. For example, the composite magnetic wire in a twisted state can be obtained by rotating the first heat treated material only in one direction. Alternatively, when the first heat treated material is rotated in clockwise and counterclockwise directions, the composite magnetic wire in a twisted state can be obtained by setting so that the total number of clockwise rotations and the total number of counterclockwise rotations may be different from each other. When the composite magnetic wire in a twisted state is manufactured, the conditions of twisting may be appropriately selected so that angle θt of twist mark 50 shown in FIG. 6 may be the above-described specific range. Specifically, twisting may be performed so that angle θt of twist mark 50 may be 4° or more and 60° or less.

### (Other Steps)

The method for manufacturing a composite magnetic wire of an embodiment may comprise a step of subjecting the first heat treated material after being twisted to the second heat treatment after the above-mentioned fourth step of twisting, or may comprise a step of subjecting the first heat treated material during being twisted to the second heat treatment simultaneous with the above step of twisting. The step of performing the second heat treatment is the same as the step of performing the second heat treatment in the above-described method for manufacturing a magnetic wire. The second heat treatment is the same as the second heat treatment described in the above-described method for manufacturing a magnetic wire, and thus the detailed description is omitted.

### (Application)

Magnetic wire 1 and composite magnetic wire 2 of the embodiments can be suitably used for, for example, the core of a magnetic sensor. In magnetic wire 1 and composite magnetic wire 2 of the embodiments, high output can be obtained and the magnetic sensor can achieve high output. In addition, in magnetic wire 1 and composite magnetic wire 2 of the embodiments, high output can be obtained and the variation in output is small, so that stable output is easily obtained even with a small diameter or length. Thus, miniaturization of the magnetic sensor can be achieved. The magnetic sensor can be utilized for, for example, a magnetic encoder, a motor, and a water meter.

### Test Example 1

Samples of magnetic wires shown in Table 1 and Table 2 were prepared under various conditions. The produced magnetic wires were evaluated.

### (Production of Sample)

Samples of magnetic wires were produced by the above-described method for manufacturing a magnetic wire. Herein, each material made of an alloy having a composition shown in Table 1 was prepared. The content of each element shown in Table 1 is a value when the total content of the elements contained in the alloy is taken as 100% by mass. In Table 1, “bal.” in the column “Fe” represents a balance. The material was manufactured by melting the alloy under vacuum, and then hot working the molten alloy into a wire shape. The diameter of the material is 2.0 mm.

The material was drawn to obtain a drawn wire. The shape of the drawn wire is a round wire. That is, the shape of the transverse section of the drawn wire is a circular shape. The diameter of the drawn wire is 0.3 mm. The total rate of work is 97.75%. Drawing was performed by cold drawing. Herein, drawing was performed a plurality of times, and an intermediate heat treatment was performed during drawing. The intermediate heat treatment was conducted once at a stage where the material was drawn to have a diameter of 0.6 mm. After the intermediate heat treatment was conducted, drawing was conducted until the diameter of the drawn wire reached 0.3 mm. The rate of work after the intermediate heat treatment and until the final drawing was set to 75%. The temperature of the intermediate heat treatment was set to 800° C. The time for the intermediate heat treatment was set to 60 minutes. The intermediate heat treatment was performed in a hydrogen atmosphere. The cooling rate after the intermediate heat treatment was set to 10° C./seconds or more.

The drawn wire was subjected to the first heat treatment. The temperature of the first heat treatment was the temperature shown in Table 2. The time for the first heat treatment was set to 60 minutes. The first heat treatment was performed in a hydrogen atmosphere. After the first heat treatment was performed, the first heat treated material subjected to the first heat treatment was cooled to room temperature. The cooling rate after the first heat treatment was set to 10° C./seconds or more.

The first heat treated material was twisted. Herein, the first heat treated material was cut into a length of 50 mm. Each of both ends of the cut first heat treated material was gripped with a chuck, and the cut first heat treated material was twisted by rotating either one chuck. In this case, the part other than both ends of the first heat treated material gripped with chucks is twisted. The length of each end part of the first heat treated material gripped by a chuck was set to 10 mm so that the distance between chucks was 30 mm. The length of the part other than both ends of the first heat treated material gripped with chucks corresponds to above length L of the first heat treated material to be twisted. That is, the length of the part to be twisted is 30 mm.

Twisting was performed under such conditions that the amount of strain on the surface of the twisted first heat treated material was the amount of strain shown in Table 2. Twisting was performed by cold twisting. For example, the conditions of twisting of Sample No. 1 were the following conditions: the operation in which twisting is performed 6 times in clockwise direction, 12 times in counterclockwise direction, and 6 times in clockwise direction, in the order presented, is determined as one set, and this set is repeated three times. In Sample No. 101 to Sample No. 103, and Sample No. 107, wire breaking due to twisting easily occurred as compared with other samples, and thus, it was difficult to perform twisting such that a sufficient amount of strain was obtained. In Sample No. 101 to Sample No. 103, and Sample No. 107, twisting was performed so that the amount of strain was less than 1.0, specifically, 0.5 or less. In Table 2, when the column “Amount of strain” is “<1.0”, it indicates that the amount of strain is less than 1.0.

After twisting was performed, the twisted first heat treated material was cut into a length of 13 mm. In Sample No. 4, the twisted first heat treated material was subjected to the second heat treatment. The temperature of the second heat treatment was set to 350° C. The time for the second heat treatment was set to 60 minutes. In Table 2, when the column “Second heat treatment Yes/No” is “No”, it indicates that the second heat treatment was not performed, and when it is “Yes”, it indicates that the second heat treatment was performed. After the second heat treatment was performed, the second heat treated material subjected to the second heat treatment was cooled to room temperature.

The produced sample of the magnetic wire is a round wire having a diameter of 0.3 mm and a length of 13 mm.

### (Composition)

The composition of the magnetic wire of each sample was examined by using ICP optical emission spectrometry. The composition of the magnetic wire is substantially the same as the composition of the material, as shown in Table 1.

### (Structure)

The structure of the magnetic wire of each sample was examined by using SEM-EBSD. Specifically, with respect to the structure of the magnetic wire of each sample, the area proportion of the α phase, the KAM value of the α phase, the average crystal grain size of the α phase, the proportion of the high angle grain boundary, and the proportion of the Σ3 grain boundary were determined. Herein, a transverse section was taken by cutting the magnetic wire in a plane orthogonal to the length of the magnetic wire. This transverse section was polished. The polished transverse section was subjected to crystal analysis by the EBSD method. The size of the observation field when the area proportion of the α phase, the average crystal grain size of the α phase, the proportion of the high angle grain boundary, the proportion of the 23 grain boundary, and the KAM value of the α phase measured was 11 μm×34 μm. In one transverse section, four points arranged at equal intervals on a line passing through the center of the transverse section are observed. SUPRA 35VP manufactured by Carl Zeiss was used as the measurement apparatus. The conditions of EBSD were such that the accelerating voltage of the electron beam was 15 kV and the scanning interval of the electron beam was 0.05 μm. OIM Analysis Version7.3 manufactured by TSL solutions K.K. was used as the analysis software. In addition, data points having a confidence index of 0.1 or more in this analysis software were employed.

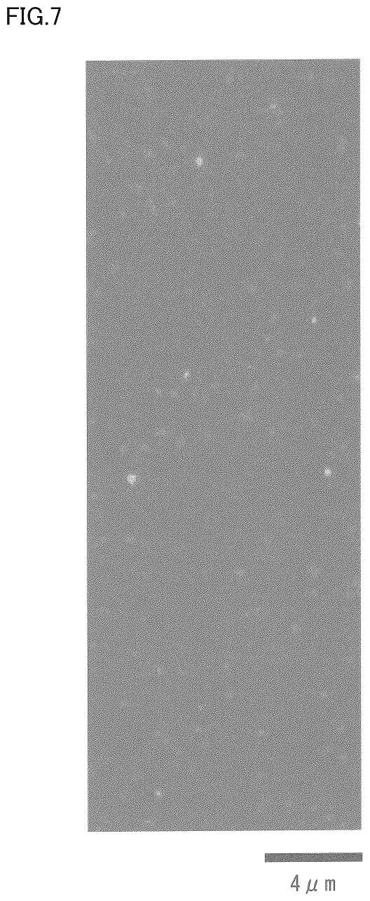

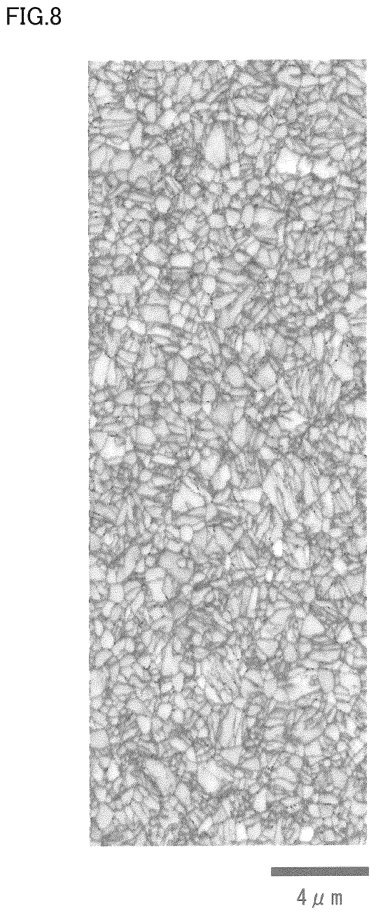

FIG. 7 is α phase map of Sample No. 1 obtained by the EBSD method. The phase map shown in FIG. 7 represents the α phase as red and the γ phase as green. In FIG. 7, the red α phase is represented by dark gray and the green γ phase is represented by light gray. FIG. 8 is an IQ map of Sample No. 1 obtained by the EBSD method. In the IQ map shown in FIG. 8, a boundary having a misorientation of 15° or more is defined as the grain boundary.

### <Area Proportion of α Phase>

The area of the α phase and the area of the γ phase in the observation field were measured based on the analysis results of the crystal structure obtained by the EBSD method. The B2 ordered phase was detected as the α phase. However, when the temperature range of the first heat treatment was more than 750° C. and 850° C. or less and the second heat treatment was not performed, almost no B2 ordered phase is considered to be formed. The area proportion of the α phase was calculated as a proportion obtained by dividing the area of the α phase by the total area of the α phase and the γ phase. The area proportion of the α phase was determined for all observation fields at above-mentioned four points, and the average value thereof was taken as the area proportion of the α phase. The measurement results of the area proportion of the α phase are shown in Table 2. In addition, the proportion of the total area of the α phase and the γ phase in the observation field was determined. The proportion of the total area of the α phase and the γ phase was calculated as a proportion obtained by dividing the total area of the α phase and the γ phase by the area of the observation field. Also, the average value of all observation fields at above-mentioned four points was taken as the proportion of the total area of the α phase and the γ phase. As a result, the proportion of the total area of the α phase and the γ phase was 98% or more in all samples.

### <KAM Value of α Phase>

The KAM value of the α phase in the observation field was measured based on the analysis results of the crystal orientation obtained by the EBSD method. The KAM value of the α phase was determined for all observation fields at above-mentioned four points, and the average value thereof was taken as the KAM value of the α phase. The measurement results of the KAM value of the α phase are shown in Table 2.

### <Average Crystal Grain Size of α Phase>

The average crystal grain size of the α phase in the observation field was measured based on the analysis results of the crystal orientation obtained by the EBSD method. Herein, a grain boundary where the misorientation between adjacent crystal grains is 15° or more is defined as the grain boundary. The area weighted average grain size of the α phase was determined for all observation fields at above-mentioned four points, and the average value thereof was taken as the average crystal grain size of the α phase. The measurement results of the average crystal grain size of the α phase are shown in Table 2.

### <Proportion of High Angle Grain Boundary>

The grain boundaries in the observation field were divided into high angle grain boundaries and low angle grain boundaries based on the analysis results of the crystal orientation obtained by the EBSD method, and the length of the high angle grain boundary and the length of the low angle grain boundary were measured. Herein, a grain boundary having a misorientation of 15° or more is defined as the high angle grain boundary, and a grain boundary having a misorientation of 2° or more and less than 15° is defined as the low angle grain boundary. The total value of the length of the high angle grain boundary and the length of the low angle grain boundary is determined as the total length of grain boundaries. The proportion of the high angle grain boundary was calculated as a proportion obtained by dividing the length of the high angle grain boundary by the total length of grain boundaries. The proportion of the high angle grain boundary was determined for all observation fields at above-mentioned four points, and the average value thereof was taken as the proportion of the high angle grain boundary. The measurement results of the proportion of the high angle grain boundary are shown in Table 2.

### <Proportion of Σ3 Grain Boundary>

The Σ3 grain boundary was separated from grain boundaries in the observation field based on the analysis results of the crystal orientation obtained by the EBSD method, and the length of the Σ3 grain boundary was measured. The proportion of the 23 grain boundary was calculated as a proportion obtained by dividing the length of the 23 grain boundary by the total length of grain boundaries. The proportion of the 23 grain boundary was determined for all observation fields at above-mentioned four points, and the average value thereof was taken as the proportion of the 23 grain boundary. The measurement results of the proportion of the Σ3 grain boundary are shown in Table 2.

(Output characteristics)

The output characteristics of the magnetic wire of each sample were evaluated. The evaluation of the output characteristics was performed as follows. A coil component in which the magnetic wire was arranged in the coil was produced. An alternating magnetic field was applied from the outside of the coil component, and the pulse voltage generated in the coil was measured over time. The test conditions were as follows. The measured pulse voltage is shown in Table 2 as output. In addition, the variation in the pulse voltage is shown in Table 2 as the coefficient of variation. However, the coefficient of variation was not determined for Sample No. 101 to Sample No. 104, Sample No. 107, and Sample No. 110.

(Test conditions)

The number of turns of the coil is 3000 turns. The length of the coil is 10 mm.

Four magnets and a rotary disc are prepared. The size of each magnet is 9 mm in length×5 mm in width×2.5 mm in thickness. Each of four magnets is arranged on the rotary disc around the center shaft of the rotary disc shifted by 90°. Each magnet is arranged around the center shaft of the rotary disc so that polarities alternate with each other. By rotating the rotary disc on which four magnets are arranged at a certain speed, an alternating magnetic field is generated. The magnetic field acting on the magnetic wire is this alternating magnetic field. The larger the rotational speed of the rotary disc is, the more the pulse voltage generated in the coil increases.

The distance between the side surface of the coil and the side surface of the magnet is 8 mm.

The rotational speed of the rotary disc is 60 revolutions per minute (rpm).

### (Measurement of Pulse Voltage)

While an alternating magnetic field is applied to the coil, a positive pulse voltage and a negative pulse voltage are alternately generated in the coil. The pulse voltage was determined as follows. The pulse voltage was measured until the number of pulses reached 2000 pulses in total. That is, the positive pulse voltage and the negative pulse voltage were measured until each of the number of positive pulse voltages and the number of negative pulse voltages reached 1000 pulses. The difference between the average value of the positive pulse voltages and the average value of the negative pulse voltages was determined, and this was taken as the pulse voltage. Further, the coefficient of variation of the pulse voltage was determined. The coefficient of variation of the pulse voltage is an index representing the variation in output. The smaller the coefficient of variation of the pulse voltage is, the smaller the variation in output is. The coefficient of variation of the pulse voltage is a value obtained by dividing the standard deviation of the positive pulse voltage by the average value of the positive pulse voltage expressed as the percentage. When the coefficient of variation is 7% or less, stable output is obtained. The coefficient of variation may be 6% or less, or may further be 5% or less.

TABLE 1

| Sample | Composition (% by mass) | | | | | | |
|---|---|---|---|---|---|---|---|
| No. | Fe | Co | V | Si | Ti | Al | Mn |
| 1 | bal. | 52.4 | 9.3 | 0.05 | 0.005 | 0.03 | 0.07 |
| 2 | bal. | 51.2 | 9.0 | 0.05 | 0.003 | 0.02 | 0.08 |
| 3 | bal. | 52.3 | 9.6 | 0.04 | 0.002 | 0.05 | 0.12 |
| 4 | bal. | 52.0 | 9.3 | 0.05 | 0.005 | 0.03 | 0.12 |
| 5 | bal. | 51.1 | 5.2 | 0.09 | 0.008 | 0.03 | 0.10 |
| 6 | bal. | 52.0 | 11.8 | 0.06 | 0.005 | 0.15 | 0.07 |
| 7 | bal. | 52.0 | 9.0 | 0.04 | 0.004 | 0.08 | 1.10 |
| 8 | bal. | 49.5 | 9.9 | 0.06 | 0.007 | 0.60 | 0.12 |
| 9 | bal. | 51.5 | 10.0 | 0.05 | 0.110 | 0.07 | 0.15 |
| 10 | bal. | 52.0 | 9.8 | 0.45 | 0.004 | 0.05 | 0.11 |
| 11 | bal. | 52.1 | 9.2 | 0.05 | 0.005 | 0.02 | 0.11 |
| 12 | bal. | 54.0 | 7.1 | 0.05 | 0.002 | 0.03 | 0.07 |
| 13 | bal. | 50.5 | 9.9 | 0.31 | 0.00 | 0.01 | 0.65 |
| 101 | bal. | 53.0 | 10.0 | 0.05 | 0.005 | 0.10 | 0.05 |
| 102 | bal. | 52.1 | 9.5 | 0.02 | 0.010 | 0.07 | 0.12 |
| 103 | bal. | 51.8 | 8.9 | 0.04 | 0.005 | 0.01 | 0.07 |
| 104 | bal. | 52.0 | 9.5 | 0.05 | 0.006 | 0.03 | 0.12 |
| 105 | bal. | 51.0 | 9.4 | 0.01 | 0.002 | 0.12 | 0.08 |
| 106 | bal. | 52.0 | 9.3 | 0.03 | 0.005 | 0.03 | 0.12 |
| 107 | bal. | 51.0 | 1.1 | 0.05 | 0.005 | 0.05 | 0.10 |
| 108 | bal. | 50.0 | 16.0 | 0.05 | 0.002 | 0.03 | 0.07 |
| 109 | bal. | 35.0 | 10.0 | 0.08 | 0.005 | 0.05 | 0.03 |
| 110 | bal. | 71.0 | 8.0 | 0.07 | 0.001 | 0.03 | 0.04 |

TABLE 2

| | | | | | | Structure | | | | | | |
|---|---|---|---|---|---|---|---|---|---|---|---|---|
| | First heat | | | | | | KAM | Average | Proportion | | | |
| | treatment | | Second | | | Area | value | crystal | of high | Proportion | | |
| | Temper- | Twisting | heat | Magnetic wire | | proportion | of α | grain size | angle grain | of Σ3 grain | | Coefficient |
| Sample | ature | Amount | treatment | Diameter | Length | of α phase | phase | of α phase | boundary | boundary | Output | of variation |
| No. | (° C.) | of strain | Yes/No | (mm) | (mm) | (%) | (°) | (μm) | (%) | (%) | (V) | (%) |
| 1 | 800 | 2.3 | No | 0.3 | 13 | 99.10 | 0.59 | 0.92 | 79.2 | 11.1 | 22.0 | 4 |
| 2 | 801 | 1.1 | No | 0.3 | 13 | 98.75 | 0.53 | 0.95 | 79.0 | 10.0 | 19.0 | 4 |
| 3 | 800 | 4.5 | No | 0.3 | 13 | 99.95 | 0.74 | 0.94 | 75.0 | 8.3 | 24.0 | 5 |
| 4 | 799 | 2.3 | Yes | 0.3 | 13 | 99.90 | 0.62 | 1.04 | 79.3 | 15.4 | 24.4 | 4 |
| 5 | 820 | 1.3 | No | 0.3 | 13 | 99.65 | 0.56 | 1.64 | 82.6 | 11.4 | 19.6 | 6 |
| 6 | 790 | 4.1 | No | 0.3 | 13 | 99.10 | 0.67 | 0.71 | 72.0 | 8.2 | 22.0 | 5 |
| 7 | 805 | 2.5 | No | 0.3 | 13 | 99.60 | 0.63 | 1.10 | 84.8 | 17.2 | 26.0 | 4 |
| 8 | 803 | 2.4 | No | 0.3 | 13 | 98.20 | 0.61 | 0.89 | 75.3 | 14.0 | 24.0 | 4 |
| 9 | 802 | 3.0 | No | 0.3 | 13 | 99.92 | 0.60 | 0.93 | 80.1 | 12.5 | 25.0 | 4 |
| 10 | 800 | 2.3 | No | 0.3 | 13 | 98.95 | 0.56 | 0.96 | 76.2 | 11.3 | 24.0 | 4 |
| 11 | 850 | 1.5 | No | 0.3 | 13 | 97.50 | 0.48 | 2.42 | 81.0 | 10.2 | 18.0 | 7 |
| 12 | 810 | 2.3 | No | 0.3 | 13 | 99.30 | 0.54 | 1.91 | 78.8 | 13.5 | 21.0 | 7 |
| 13 | 800 | 1.8 | No | 0.3 | 13 | 99.90 | 0.55 | 1.02 | 76.0 | 14.2 | 25.8 | 4 |
| 101 | 450 | <1.0 | No | 0.3 | 13 | 99.10 | 0.91 | 0.35 | 44.2 | 1.1 | 2.9 | — |
| 102 | 550 | <1.0 | No | 0.3 | 13 | 94.90 | 0.79 | 9.20 | 44.9 | 1.4 | 0.44 | — |
| 103 | 650 | <1.0 | No | 0.3 | 13 | 81.10 | 0.57 | 5.03 | 51.0 | 2.1 | 0.22 | — |
| 104 | 750 | 3.2 | No | 0.3 | 13 | 52.30 | 0.34 | 1.50 | 68.3 | 8.0 | 0.22 | — |
| 105 | 900 | 2.2 | No | 0.3 | 13 | 99.90 | 0.51 | 5.10 | 80.5 | 11.2 | 13.2 | 9 |
| 106 | 1000 | 3.1 | No | 0.3 | 13 | 99.80 | 0.50 | 8.20 | 80.3 | 14.0 | 12.3 | 9 |
| 107 | 798 | <1.0 | No | 0.3 | 13 | 99.90 | 0.34 | 11.00 | 73.5 | 3.0 | 6.6 | — |
| 108 | 805 | 2.2 | No | 0.3 | 13 | 88.00 | 0.36 | 5.21 | 77.0 | 3.2 | 10.5 | 8 |
| 109 | 810 | 2.2 | No | 0.3 | 13 | 99.00 | 0.37 | 4.56 | 74.0 | 4.5 | 12.0 | 8 |
| 110 | 790 | 2.2 | No | 0.3 | 13 | 80.00 | 0.35 | 12.00 | 77.7 | 4.5 | 4.5 | — |

The magnetic wires of Sample No. 1 to Sample No. 13 have an output of 15 V or more and excellent in output characteristics. Further, the magnetic wires of Sample No. 1 to Sample No. 13 have a coefficient of variation of 7% or less, and the variation in output is small. Each of the magnetic wires of Sample No. 1 to Sample No. 13 has a specific structure. Specifically, the structure of these magnetic wires satisfies all of the following three requirements: the area proportion of the α phase is 90% or more, the average crystal grain size of the α phase is 2.5 μm or less, and the proportion of the high angle grain boundary is 60% or more. Further, the structure of these magnetic wires satisfies both the proportion of the Σ3 grain boundary of 5% or more and the KAM value of the α phase of 0.45° or more, in addition to the above-described three requirements.

In contrast, the magnetic wires of Sample No. 101 to Sample No. 110 have an output of less than 15 V and are inferior in output characteristics as compared with the magnetic wires of Sample No. 1 to Sample No. 13. Each structure of the magnetic wires of Sample No. 101 to Sample No. 110 does not satisfy at least one requirement among the above-described three requirements. In addition, in each structure of the magnetic wires of Sample No. 101 to Sample No. 103, the proportion of the high angle grain boundary and the proportion of the Σ3 grain boundary are small.

For these reasons, it is found that, in the magnetic wire having a specific structure, high output can be obtained and stable output is obtained.

Moreover, the followings are found from this test results.

(1) In comparison of No. 1 to No. 3, the larger the amount of strain by twisting is, the more easily high output is obtained.

(2) In comparison between No. 1 and No. 4, output characteristics are improved by performing the second heat treatment.

(3) In comparison of No. 5, No. 6, and No. 107, twisting is easy by containing a certain amount of V as the additive element. It is considered from the results that the content of V is preferably 2% by mass or more, and particularly preferably 5% by mass or more. As a result of No. 108, too much content of V may result in a case where the specific structure is not obtained and may result in the reduction of output characteristics. Thus, it is considered that the upper limit of the content of Vis preferably 12% by mass.

In comparison of No. 8, No. 12, No. 109, and No. 110, output characteristics are improved by containing Co in a specific range. It is considered from the results that the content of Co is preferably 40% by mass or more and 70% by mass or less. In addition, as a result of No. 110, too much content of Co may result in a case where the specific structure is not obtained and may result in the reduction of output characteristics.

(4) In comparison of No. 1, No. 7 to No. 10, further high output is easily obtained by containing a certain amount of at least one of Si, Ti, Al, and Mn as the additive element. It is considered from the results that the content of Si is preferably 0.1% by mass or more, and further preferably 0.2% by mass or more. It is considered that the content of Ti is preferably 0.05% by mass or more, and further preferably 0.08% by mass or more. It is considered that the content of Al is preferably 0.2% by mass or more, and further preferably 0.3% by mass or more. It is considered that the content of Mn is preferably 0.2% by mass or more, and further preferably 0.4% by mass or more.

(5) In comparison of No. 1 to No. 11, and No. 107, the relatively larger the KAM value of the α phase is, the more easily high output is obtained. It is considered from this comparison results that the KAM value of the α phase is preferably 0.47° or more, and further preferably 0.50° or more. The reason why the KAM value of the α phase is small in No. 107 is considered due to the small amount of strain by twisting. The reason why the KAM value of the ox phase in No. 11 is smaller than the KAM values of the α phase in No. 1 to No. 10 is considered because the temperature of the first heat treatment is relatively high. It is considered from this result that the temperature of the first heat treatment is, in the case of the compositions shown in Table 1, preferably 840° C. or less, and more preferably 820° C. or less.

(6) In comparison between No. 1 to No. 12 in which the first heat treatment temperature was in the range of more than 750° C. and 850° C. or less and No. 101 to No. 104, it is difficult to perform twisting such that a sufficient amount of strain is obtained, when the temperature of the first heat treatment is too low. Thus, high output is hardly obtained. In addition, as the results of No. 101 to No. 104, when the temperature of the first heat treatment is low, the specific structure that satisfies all of the above-described three requirements cannot be obtained. In No. 101, the proportion of the high angle grain boundary is small. In No. 102, the proportion of the high angle grain boundary is small and the average crystal grain size of the α phase is large. In No. 103, the area proportion of the α phase and the proportion of the high angle grain boundary are small, and the average crystal grain size of the α phase is large. In each of No. 101 to No. 103, the proportion of the Σ3 grain boundary is small. In No. 104, the area proportion of the α phase is small, and further, the KAM value of the α phase is small. The reason why the area proportion of the α phase in No. 101 and No. 102 is large is considered because the state of the structure of the wire before being subjected to the first heat treatment was relatively maintained due to too low temperature of the first heat treatment. The reason why the proportion of the high angle grain boundary and the proportion of the Σ3 grain boundary are small in No. 101 to No. 103 is considered because the phase was not transformed to the γ phase during heat treatment due to low temperature of the first heat treatment, so that martensitic transformation did not occur during cooling. The reason why the average crystal grain size of the α phase is large in No. 102 and No. 103 is considered due to recrystallization. The reason why the area proportion of the α phase is small in No. 103 and No. 104 is considered because V was segregated in the γ phase by the first heat treatment, so that the γ phase was stabilized. For these reasons, it is considered that the temperature of the first heat treatment is, in the case of the compositions shown in Table 1, preferably more than 750° C., and more preferably 760° C. or more. Considering the result of No. 6, it is considered that the temperature of the first heat treatment is preferably 780° C. or more, and more preferably 790° C. or more.

(7) Further, as the results of No. 105 and No. 106, too high temperature of the first heat treatment increases the average crystal grain size of the α phase, so that the specific structure cannot be obtained.

### Test Example 2

In Test Example 2, samples of magnetic wires in which at least one of the diameter and the length is different from those of Test Example 1 was produced.

### (Production of Sample)

Samples of magnetic wires of Test Example 2 shown in Table 3 and Table 4 were produced in the same manner as in Test Example 1. Hereinafter, the description will be made on the samples of Test Example 2 for the matters different from the samples of Test Example 1, and the description is omitted for the matters similar to the samples of Test Example 1.

In Test Example 2, each material made of an alloy having a composition shown in Table 3 was prepared. The diameter of the material was 2.0 mm.

In Sample No. 21 and Sample No. 22, the diameter of the magnetic wire was different from that of Test Example 1. In Sample No. 21, the diameter of the drawn wire was set to 0.2 mm. The total rate of work of drawing in Sample No. 21 is 99%. In Sample No. 21, the intermediate heat treatment was conducted once at a stage where the material was drawn to have a diameter of 0.6 mm, as in Test Example 1. In Sample No. 21, the rate of work after the intermediate heat treatment and until the final drawing was 89%. In Sample No. 22, the diameter of the drawn wire was set to 0.55 mm. The total rate of work of drawing in Sample No. 22 was 92%. Also in Sample No. 22, the intermediate heat treatment was conducted once at a stage where the material was drawn to have a diameter of 0.6 mm. In Sample No. 22, the rate of work after the intermediate heat treatment and until the final drawing was 16%.

In Test Example 2, the temperature of the first heat treatment was the temperature shown in Table 4. Twisting was performed under such conditions that the amount of strain shown in Table 4 was obtained.

After twisting was performed, the twisted first heat treated material was cut. In Sample No. 21, the first heat treated material was cut into a length of 13 mm. In Sample No. 22 to Sample No. 25, the length of the magnetic wire is different from that of Test Example 1. In Sample No. 22, the first heat treated material was cut into a length of 10 mm. In Sample No. 23, the first heat treated material was cut into a length of 7 mm. In Sample No. 24, the first heat treated material was cut into a length of 8.5 mm. In Sample No. 25, the first heat treated material was cut into a length of 15 mm.

The composition of the magnetic wire of each sample was examined by ICP optical emission spectrometry. The composition of the magnetic wire is substantially the same as the composition of the material, as shown in Table 3.

The structure of the magnetic wire of each sample was examined by using SEM-EBSD. As in Test Example 1, the area proportion of the α phase, the KAM value of the α phase, the average crystal grain size of the α phase, the proportion of the high angle grain boundary, and the proportion of the Σ3 grain boundary were determined. The results are shown in Table 4.

The output characteristics of the magnetic wire of each sample were evaluated in the same manner as in Test Example 1. The results are shown in Table 4.

TABLE 3

| Sample | Composition (% by mass) | | | | | | |
|---|---|---|---|---|---|---|---|
| No. | Fe | Co | V | Si | Ti | Al | Mn |
| 21 | bal. | 52.3 | 9.2 | 0.05 | 0.002 | 0.02 | 0.09 |
| 22 | bal. | 49.8 | 9.3 | 0.03 | 0.003 | 0.02 | 0.08 |
| 23 | bal. | 51.2 | 9.6 | 0.09 | 0.002 | 0.03 | 0.07 |
| 24 | bal. | 47.9 | 9.5 | 0.05 | 0.004 | 0.04 | 0.07 |
| 25 | bal. | 50.0 | 9.3 | 0.02 | 0.005 | 0.03 | 0.07 |

TABLE 4

| | | | | | | Structure | | | | | | |
|---|---|---|---|---|---|---|---|---|---|---|---|---|
| | First heat | | | | | | KAM | Average | Proportion | | | |
| | treatment | | Second | | | Area | value | crystal | of high | Proportion | | |
| | Temper- | Twisting | heat | Magnetic wire | | proportion | of α | grain size | angle grain | of Σ3 grain | | Coefficient |
| Sample | ature | Amount | treatment | Diameter | Length | of α phase | phase | of α phase | boundary | boundary | Output | of variation |
| No. | (° C.) | of strain | Yes/No | (mm) | (mm) | (%) | (°) | (μm) | (%) | (%) | (V) | (%) |
| 21 | 800 | 2.3 | No | 0.2 | 13 | 99.20 | 0.58 | 1.92 | 81.0 | 13.2 | 17.0 | 4 |
| 22 | 800 | 2.3 | No | 0.55 | 10 | 99.15 | 0.76 | 1.33 | 73.5 | 11.3 | 23.3 | 6 |
| 23 | 800 | 2.3 | No | 0.3 | 7 | 99.50 | 0.58 | 1.77 | 83.0 | 18.9 | 17.5 | 7 |
| 24 | 800 | 2.3 | No | 0.3 | 8.5 | 98.95 | 0.70 | 1.15 | 71.0 | 8.9 | 19.0 | 6 |
| 25 | 800 | 2.3 | No | 0.3 | 15 | 99.90 | 0.56 | 0.65 | 74.9 | 16.1 | 24.0 | 4 |

The magnetic wires of Sample No. 21 to Sample No. 25 have an output of 15 V or more, a coefficient of variation of 7% or less, and have high output characteristics. Each of the magnetic wires of Sample No. 21 to Sample No. 25 has the specific structure, as in Sample No. 1 to Sample No. 13 of Test Example 1 shown in Table 2. Sample No. 21 has sufficient output characteristics even with a small diameter of the magnetic wire. Sample No. 23 has sufficient output characteristics even with a small length of the magnetic wire. It is found from the test results that the magnetic wire having the specific structure can secure sufficient output characteristics even with a small size.

### Test Example 3

Samples of composite magnetic wires shown in Table 6 and Table 7 were prepared under various conditions. The produced composite magnetic wires were evaluated.

### (Production of Sample)

Samples of composite magnetic wires were produced by the above-described method for manufacturing a composite magnetic wire. Herein, a core material made of an alloy having the same composition as Sample No. 1 of Test Example 1 and a core material made of Fe-65Ni alloy were prepared. As shown in Table 6, the core material of Sample No. 31 to Sample No. 49, and Sample No. 111 is made of FeCoV alloy. The core material of Sample No. 112 is made of Fe-65Ni alloy. Fe-65Ni alloy is an alloy comprising 65% by mass of Ni, and the balance with Fe and inevitable impurities. The melting point of Fe-65Ni is 1250° C. The melting point of the alloy that constitutes the core material is shown in Table 5. The core material was manufactured by melting the alloy under vacuum, and then hot working the molten alloy into a wire shape. The shape of the core material is a round wire. That is, the shape of the transverse section of the core material is a circular shape. The diameter of the core material is 2.0 mm.

The outer peripheral surface of the core material was coated with a coating material to obtain a coated wire. Herein, coating was performed with a coating material made of any one metal shown in Table 5. The material of the coating material is any one of SUS304L, SUS316L, permalloy B, nichrome, phosphor bronze, or FeCoV alloy. The melting points of each metal constituting the coating material are shown in Table 5. As shown in Table 6, the coating material of Sample No. 31 to Sample No. 45, Sample No. 49, and Sample No. 111 is made of SUS316L. The coating material of Sample No. 46 is made of SUS304L. The coating material of Sample No. 47 is made of nichrome. The coating material of Sample No. 48 is made of permalloy B. The coating material of Sample No. 112 is made of FeCoV alloy. The composition of the coating material made of FeCoV alloy is a composition comprising 52% by mass of Co, 10% by mass of V, and the balance with Fe and inevitable impurities. The melting point of this FeCoV alloy is about 1300° C. The outer peripheral surface of a core material was coated with the coating material by the cladding method. Specifically, the outer peripheral surface of the core material was cladded with the coating material by drawing a pipe made of a metal that constitutes the coating material, with the core material inserted therein. The internal diameter of the above pipe was about 2.1 mm. The thickness of the above pipe was adjusted so that the ratio of the core material in the sample of the composite magnetic wire was each value shown in Table 6.

TABLE 5

| Material of core material | Melting point |
|---|---|
| or coating material | (° C.) |
| FeCoV | About 1300 |
| Fe—65 Ni | 1250 |
| SUS304L | 1300 or more |
| SUS316L | 1300 or more |
| Permalloy B | 1250 |
| Nichrome | 1300 or more |

The coated wire was drawn to obtain a drawn wire. The shape of the drawn wire is a round wire. That is, the shape of the transverse section of the drawn wire is a circular shape. The diameter of the drawn wire is 0.3 mm or 0.4 mm. In Sample No. 49, the diameter of the drawn wire is 0.4 mm. In samples other than Sample No. 49, the diameter of the drawn wire is 0.3 mm. The total rate of work is more than 97.75%. Drawing was performed by cold drawing. Herein, drawing was performed a plurality of times, and an intermediate heat treatment was conducted during drawing. The intermediate heat treatment was conducted once at a stage where the coated wire was drawn to have a diameter of 0.6 mm. After the intermediate heat treatment was conducted, drawing was performed until the diameter of the drawn wire reached 0.3 mm. The rate of work after the intermediate heat treatment and until the final drawing was set to 75%. The temperature of the intermediate heat treatment was set to 800° C. The time for the intermediate heat treatment was set to 60 minutes. The intermediate heat treatment was performed in a hydrogen atmosphere. The cooling rate after the intermediate heat treatment was set to 10° C./seconds or more.

The drawn wire was subjected to the first heat treatment. The temperature of the first heat treatment was the temperature shown in Table 6. The time for the first heat treatment was set to 60 minutes. The first heat treatment was performed in a hydrogen atmosphere. After the first heat treatment was performed, the first heat treated material subjected to the first heat treatment was cooled to room temperature. The cooling rate after the first heat treatment was set to 10° C./seconds or more.

The first heat treated material was twisted. The method for twisting was the same as in Test Example 1. Twisting was performed under such conditions that the amount of strain shown in Table 6 was obtained. In Sample No. 31 to Sample No. 49, Sample No. 111, and Sample No. 112, twisting was completed in a state where the first heat treated material was twisted. Specifically, when the first heat treated material was twisted, the total number of clockwise rotations and the total number of counterclockwise rotations were adjusted to be different from each other.

After twisting was performed, the twisted first heat treated material was cut into a length of 13 mm or 10 mm. Sample No. 49 was cut into a length of 10 mm. Samples other than Sample No. 49 was cut into a length of 13 mm. In Sample No. 36, the twisted first heat treated material is subjected to the second heat treatment. The temperature of the second heat treatment was set to 300° C. The time for the second heat treatment was set to 60 minutes. In Table 6, when the column “Second heat treatment Yes/No” is “No”, it indicates that the second heat treatment was not performed, and when it is “Yes”, it indicates that the second heat treatment was performed. After the second heat treatment was performed, the second heat treated material subjected to the second heat treatment was cooled to room temperature.

Each of the produced samples of the composite magnetic wires is a round wire having a diameter of 0.3 mm and a length of 13 mm except for Sample No. 49. The composite magnetic wire of Sample No. 49 is a round wire having a diameter of 0.4 mm and a length of 10 mm.

The magnetic wires of Sample No. 1a and Sample No. 1b were produced. Sample No. 1a and Sample No. 1b have no coating material, as in Sample No. 1 of Test Example 1. Sample No. 1a and Sample No. 1b were produced in the same manner as in Sample No. 1, except that the conditions of twisting in the manufacturing process are different. Each composition of the magnetic wires of Sample No. 1a and Sample No. 1b are substantially the same as the composition of the magnetic wire of Sample No. 1. In Sample No. 1a and Sample No. 1b, the first heat treated material was twisted under such conditions that the amount of strain shown in Table 6 was obtained. However, in Sample No. 1a and Sample No. 1b, twisting was completed in a state where the first heat treated material was twisted. That is, Sample No. 1a and Sample No. 1b are magnetic wires in a twisted state. The magnetic wire in a twisted state has a twist mark on the outer peripheral surface of the magnetic wire. Comparing Sample No. 1a and Sample No. 1b, the sum of the number of clockwise rotations and the number of counterclockwise rotations is the same when the first heat treated material is twisted, but the difference between the number of clockwise rotations and the number of counterclockwise rotations is different.

The composition of the core material in the composite magnetic wire of each sample was examined by the EDX method. The compositions of the core materials in Sample No. 31 to Sample No. 49, and Sample No. 111 were substantially the same as the composition of the magnetic wire of Sample No. 1 of Test Example 1. The material of the core material in Sample No. 112 was Fe-65Ni alloy. As a result of the analysis of the composition of the coating material by the EDX method, the material of the coating material was as shown in Table 6.

For the composite magnetic wire of each sample, the Vickers hardness of each of the core material and the coating material was determined. Each Vickers hardness was determined by the method described in the item “<Method for measuring Vickers hardness>” described above. The results are shown in Table 6. Also, with respect to each magnetic wire of Sample No. 1, Sample No. 1a, and Sample No. 1b, the Vickers hardness was determined. The Vickers hardness of the magnetic wire was determined in the same manner as the Vickers hardness of the core material. The results are also shown in Table 6.

For the composite magnetic wire of each sample, the melting point of the coating material was determined. The melting point of the coating material was determined by the method described in the item “<Method for measuring melting point>” described above. The melting point of each coating material was the same as the melting point shown in Table 5.

The ratio of the core material in the composite magnetic wire of each sample is shown in Table 6. The ratio of the core material was determined as follows. The transverse section of the composite magnetic wire was observed with an optical microscope to determine each of the diameter of the core material and the diameter of the composite magnetic wire. The ratio of the core material was determined by dividing the diameter of the core material by the diameter of the composite magnetic wire.

The angle of the twist mark in the composite magnetic wire of each sample is shown in Table 6. The angle of the twist mark was determined as follows. The outer peripheral surface of the coating material was observed with an optical microscope, and the tilt angle of the twist mark with respect to the axis line of the composite magnetic wire was measured. The tilt angles of 20 or more twist marks were measured, and the average value thereof was taken as the angle of the twist mark. For each magnetic wire of Sample No. 1a and Sample No. 1b, the angle of the twist mark was determined.

The angle of the twist mark of each magnetic wire was determined as follows. The outer peripheral surface of the magnetic wire was observed with an optical microscope, and the tilt angle of the twist mark with respect to the axis line of the magnetic wire was measured. The tilt angles of 20 or more twist marks were measured as in the sample of the composite magnetic wire, and the average value thereof was determined.

The angle of the twist mark in each magnetic wire of Sample No. 1a and Sample No. 1b is shown in Table 6.

The structure of the core material in the composite magnetic wire of each sample and the structure of each magnetic wire of Sample No. 1a and Sample No. 1b were examined using SEM-EBSD. As in Test Example 1, the area proportion of the α phase, the KAM value of the α phase, the average crystal grain size of the α phase, the proportion of the high angle grain boundary, and the proportion of the 23 grain boundary were determined. The results are shown in Table 7.

The output characteristics of the composite magnetic wire of each sample, and the output characteristics of each magnetic wire of Sample No. 1a and Sample No. 1b were evaluated in the same manner as in Test Example 1. The results are shown in Table 7.

TABLE 6

| | First heat | | Second | Composite | | | | | | Proportion | Angle of |
|---|---|---|---|---|---|---|---|---|---|---|---|
| | treatment | Twisting | heat | magnetic wire | | Core material | | Coating material | | of core | the twist |
| Sample | Temperature | Amount | treatment | Diameter | Length | | Hardness | | Hardness | material | mark |
| No. | (° C.) | of strain | Yes/No | (mm) | (mm) | Material | (HV) | Material | (HV) | (%) | (°) |
| 1 | 800 | 2.3 | No | 0.3 | 13 | FeCoV | 430 | — | — | — | — |
| 1a | 800 | 2.3 | No | 0.3 | 13 | FeCoV | 445 | — | — | — | 11.0 |
| 1b | 800 | 2.3 | No | 0.3 | 13 | FeCoV | 424 | — | — | — | 30.0 |
| 31 | 800 | 1.67 | No | 0.3 | 13 | FeCoV | 425 | SUS316L | 399 | 89.5 | 32.0 |
| 32 | 800 | 1.67 | No | 0.3 | 13 | FeCoV | 398 | | 422 | 86.6 | 31.5 |
| 33 | 800 | 1.67 | No | 0.3 | 13 | FeCoV | 445 | | 435 | 81.6 | 31.1 |
| 34 | 800 | 0.81 | No | 0.3 | 13 | FeCoV | 424 | | 388 | 75.0 | 22.5 |
| 35 | 800 | 1.05 | No | 0.3 | 13 | FeCoV | 429 | | 405 | | 32.4 |
| 36 | 800 | 1.06 | Yes | 0.3 | 13 | FeCoV | 565 | | 411 | | 29.9 |
| 37 | 800 | 1.11 | No | 0.3 | 13 | FeCoV | 441 | | 427 | | 38.0 |
| 38 | 800 | 1.27 | No | 0.3 | 13 | FeCoV | 428 | | 439 | | 44.0 |
| 39 | 800 | 1.19 | No | 0.3 | 13 | FeCoV | 433 | | 391 | | 5.1 |
| 40 | 800 | 1.51 | No | 0.3 | 13 | FeCoV | 419 | | 419 | | 23.2 |
| 41 | 800 | 1.67 | No | 0.3 | 13 | FeCoV | 447 | | 428 | | 32.8 |
| 42 | 800 | 1.83 | No | 0.3 | 13 | FeCoV | 432 | | 441 | | 39.1 |
| 43 | 800 | 1.99 | No | 0.3 | 13 | FeCoV | 410 | | 449 | | 50.5 |
| 44 | 800 | 2.72 | No | 0.3 | 13 | FeCoV | 399 | | 452 | | 31.0 |
| 45 | 800 | 1.67 | No | 0.3 | 13 | FeCoV | 406 | | 418 | 67.0 | 28.2 |
| 46 | 800 | 1.67 | No | 0.3 | 13 | FeCoV | 425 | SUS304L | 428 | 77.0 | 30.2 |
| 47 | 800 | 1.67 | No | 0.3 | 13 | FeCoV | 412 | Nichrome | 390 | 81.4 | 31.6 |
| 48 | 800 | 1.67 | No | 0.3 | 13 | FeCoV | 445 | Permalloy B | 242 | 81.3 | 32.7 |
| 49 | 800 | 1.67 | No | 0.4 | 10 | FeCoV | 430 | SUS316L | 440 | 80.0 | 30.2 |
| 111 | 802 | 1.67 | No | 0.3 | 13 | FeCoV | 430 | SUS316L | 410 | 30.0 | 32.5 |
| 112 | 250 | 1.0 | No | 0.3 | 13 | Fe—65Ni | 230 | FeCoV | 450 | 57.0 | 15.0 |

TABLE 7

| | Structure of the core material | | | | | | |
|---|---|---|---|---|---|---|---|
| | | | Average | Proportion | | | |
| | Area | | crystal | of high | Proportion | | |
| | proportion | KAM value | grain size | angle grain | of Σ3 grain | | Coefficient |
| Sample | of α phase | of α phase | of α phase | boundary | boundary | Output | of variation |
| No. | (%) | (°) | (μm) | (%) | (%) | (V) | (%) |
| 1 | 99.10 | 0.59 | 0.92 | 79.2 | 11.1 | 22.0 | 4 |
| 1a | 99.40 | 0.58 | 0.95 | 78.9 | 15.5 | 23.2 | 4 |
| 1b | 98.95 | 0.60 | 1.01 | 81.0 | 13.8 | 23.5 | 4 |
| 1 | 99.80 | 0.62 | 1.25 | 78.5 | 15.6 | 25.2 | 4 |
| 32 | 99.75 | 0.63 | 1.05 | 81.3 | 15.9 | 28.3 | 4 |
| 33 | 99.95 | 0.57 | 1.10 | 77.5 | 15.8 | 29.7 | 4 |
| 34 | 99.10 | 0.55 | 1.02 | 84.9 | 18.5 | 24.3 | 4 |
| 35 | 98.90 | 0.54 | 1.07 | 84.0 | 17.8 | 29.2 | 4 |
| 36 | 98.85 | 0.55 | 1.05 | 82.2 | 17.3 | 29.8 | 4 |
| 37 | 99.50 | 0.57 | 0.99 | 81.0 | 17.2 | 28.7 | 4 |
| 38 | 99.75 | 0.59 | 1.05 | 79.2 | 17.1 | 25.4 | 4 |
| 39 | 99.50 | 0.52 | 1.22 | 84.5 | 18.4 | 25.2 | 4 |
| 40 | 99.65 | 0.55 | 1.20 | 82.5 | 17.1 | 26.3 | 4 |
| 41 | 99.85 | 0.58 | 1.12 | 81.2 | 16.7 | 29.8 | 4 |
| 42 | 99.85 | 0.59 | 1.04 | 79.4 | 16.3 | 28.6 | 4 |
| 43 | 99.90 | 0.60 | 1.09 | 78.3 | 16.2 | 27.8 | 4 |
| 44 | 98.85 | 0.64 | 0.98 | 77.2 | 15.5 | 25.2 | 5 |
| 45 | 98.95 | 0.61 | 1.08 | 79.5 | 13.8 | 24.1 | 4 |
| 46 | 99.15 | 0.55 | 1.27 | 79.5 | 17.0 | 28.8 | 4 |
| 47 | 99.30 | 0.65 | 0.99 | 80.0 | 15.8 | 28.0 | 4 |
| 48 | 98.90 | 0.57 | 1.28 | 80.5 | 18.3 | 27.5 | 5 |
| 49 | 99.60 | 0.58 | 1.03 | 79.0 | 15.1 | 28.0 | 4 |
| 111 | 98.90 | 0.62 | 1.00 | 78.3 | 12.6 | 15.0 | 4 |
| 112 | 99 50 | 0.91 | 0.31 | 39.0 | 2.8 | 14.0 | 12 |

The composite magnetic wires of Sample No. 31 to Sample No. 49 have output characteristics higher than those of each magnetic wire of Sample No. 1, Sample No. 1a and Sample No. 1b. The composite magnetic wires of Sample No. 31 to Sample No. 49 have an output of 24 V or more. Each core material of the composite magnetic wires of Sample No. 31 to Sample No. 49 has the specific structure, as the magnetic wire of Sample No. 1. Specifically, the structure of the core material in these composite magnetic wires satisfies all of the following three requirements: the area proportion of the α phase is 90% or more, the average crystal grain size of the α phase is 2.5 μm or less, and the proportion of the high angle grain boundary is 60% or more. Further, the structure of the core material satisfies both the proportion of the 23 grain boundary of 5% or more and the KAM value of the α phase of 0.45° or more, in addition to the above-described three requirements.

The ratio of the core material in the composite magnetic wires of Sample No. 31 to Sample No. 49 is 45% or more and 95% or less. The composite magnetic wire of Sample No. 111 in which the ratio of the core material is 30% has a lower output than each magnetic wire of Sample No. 1, Sample No. 1a, and Sample No. 1b.

The composite magnetic wires of Sample No. 31 to Sample No. 49 have a coefficient of variation of 7% or less, and the variation in output is small. Sample No. 49 has sufficient output characteristics even with a small length of the composite magnetic wire. Whereas, the composite magnetic wire of Sample No. 112 has a coefficient of variation of more than 7%, and the variation in output is large. Sample No. 112 has an output of less than 15 V, and is inferior in output characteristics as compared with Sample No. 31 to Sample No. 49. The core material of the composite magnetic wire of Sample No. 112 does not have the above-described specific structure. Specifically, in the structure of the core material in the composite magnetic wire of Sample No. 112, the proportion of the high angle grain boundary is less than 60%, and further, the proportion of the Σ3 grain boundary is less than 5%.

In addition, the followings are found from this test results.

(1) In No. 31 to No. 33, No. 41, and No. 45, twisting is performed so that the amount of strain is equivalent to each other. In addition, the material of the coating material is the same in these samples. In comparison of No. 31 to No. 33, the relatively smaller the ratio of the core material is, the more easily high output is obtained. It is considered that the upper limit of the ratio of the core material is preferably 95%, further preferably 90%, and particularly preferably 85%. In comparison of No. 41 and No. 45, the relatively larger the ratio of the core material, the more easily high output is obtained. It is considered that the lower limit of the ratio of the core material is preferably 48%, further preferably 55%, and particularly preferably 60%

(2) In No. 35 to No. 43, the ratio of the core material is equivalent to each other. In addition, in these samples, the amount of strain by twisting is within the range of 1.0 or more and 2.0 or less. It is considered from the comparison of these samples that high output is easily obtained when the angle of the twist mark is 4° or more and 60° or less, further 5° or more and 55° or less, or in particular, 20° or more and 40° or less.

(3) It is considered from the comparison of No. 33 and No. 46 to No. 48, the higher the Vickers hardness of the coating material, the more easily high output is obtained. It is considered that the material of the coating material is preferably stainless steel. It is considered that the Vickers hardness of the coating material is particularly preferably 300 HV or more.

(4) In No. 34 to No. 37, No. 40 to No. 42, and No. 44, the ratio of the core material is equivalent to each other. In addition, in these samples, the angle of the twist mark is within the range of 20° or more and 40° or less. It is considered from the comparison of these samples that high output is easily obtained when the amount of strain by twisting is 0.8 or more and 3.0 or less, or further 1.0 or more and 2.0 or less.

(5) In comparison between No. 35 and No. 36, output characteristics are improved by performing the second heat treatment. In addition, the second heat treatment makes the hardness of the core material high.

### <<Supplement>>

In relation to the aforementioned embodiments of the present disclosure, the following supplements are further disclosed.

### [Supplement 1]

A method for manufacturing a composite magnetic wire, comprising:
drawing a core material made of an alloy containing iron and cobalt as main components to obtain a drawn wire,
subjecting the drawn wire to first heat treatment to obtain a first heat treated material,
coating an outer peripheral surface of the first heat treated material with a coating material to obtain a coated wire, and
twisting the coated wire, wherein
the first heat treatment is performed under such conditions that a structure of the alloy of the core material in the first heat treated material comprises an α phase and a γ phase and a proportion of an area of the α phase relative to a total area of the α phase and the γ phase in a cross section of the core material is 90% or more.

The method for manufacturing a composite magnetic wire according to supplement 1 can manufacture a composite magnetic wire excellent in output characteristics. This is because the structure of the core material in the first heat treated material is controlled by the first heat treatment so as to be a specific structure in which the α phase and the γ phase coexist. According to the method for manufacturing of supplement 1, a composite magnetic wire having high output characteristics can be obtained by twisting the first heat treated material.

In the method for manufacturing of supplement 1, twisting is performed in a state where the core material is coated with the coating material. When the composite magnetic wire is twisted, the core material is pulled by the coating material in the vicinity of the outer peripheral surface of a core material, and the core material is stretched along the length of the core material. Tensile residual stress along the length of the core material is introduced to the core material by twisting. As a result, the tensile residual stress increases, and the uniaxial anisotropy of the core material increases. Since the uniaxial anisotropy of the core material increases, the output characteristics of the core material are improved.

The method for manufacturing a composite magnetic wire according to supplement 1 is different from the above-described method for manufacturing a composite magnetic wire according to an embodiment in that the first heat treatment is conducted before coating with the coating material. In the manufacturing method of supplement 1, the steps proceed [wire drawing], [first heat treatment], [coating], and [twisting], in the order presented. In the case of the manufacturing method of supplement 1, the core material is drawn, and then the first heat treatment is conducted. Then, after the first heat treatment is performed, the first heat treated material is coated with the coating material. On the other hand, in the method for manufacturing a composite magnetic wire according to an embodiment, the steps proceed [coating], [wire drawing], [first heat treatment], and [twisting], in the order presented. In the case of the manufacturing method of the embodiment, the core material is first coated with the coating material. Then, after the coated wire is drawn, the first heat treatment is conducted. That is, in the manufacturing method of supplement 1, the core material is not coated with the coating material in the step of performing the first heat treatment. Since the first heat treatment is performed in a state where the core material is not coated with the coating material, the melting point of the coating material may be lower than the temperature of the first heat treatment. The melting point of the coating material may be 850° C. or less. In the case of the manufacturing method of supplement 1, a metal having a lower melting point than that of the coating material used in the manufacturing method of the embodiment can be used as the coating material.

In the case of the manufacturing method of supplement 1, the coating material may be formed by a plating method. When the coating material is formed by a plating method, no compression strain occurs in the first heat treated material, so that the output characteristics of the core material is hardly affected. On the other hand, when the coating material is formed by a cladding method, the compression strain occurs in the first heat treated material, so that the output characteristics of the core material may be affected. In the manufacturing method of supplement 1, the coating step is performed after the drawing step, so that no drawn wire marks remain on the surface of the coated wire. When the coated wire is twisted in the twisting step, streaky twist marks are formed on the surface of the coated wire due to the deformation of the surface of the coated wire. Thus, the composite magnetic wire obtained by the manufacturing method of supplement 1 has twist marks as the composite magnetic wire obtained by the manufacturing method of the embodiment.

### [Supplement 2]

The method for manufacturing a composite magnetic wire according to supplement 1, wherein the twisting is performed under such conditions that an amount of strain on a surface of the twisted coated wire is 0.8 or more and 3.0 or less.

According to the manufacturing method of supplement 2, a composite magnetic wire having high output characteristics can be stably manufactured. The reason why twisting is performed under such conditions that the amount of strain is 0.8 or more and 3.0 or less is the same as the above-described method for manufacturing a composite magnetic wire according to an embodiment.

### [Supplement 3]

The method for manufacturing a composite magnetic wire according to supplement 1 or supplement 2, comprising subjecting the coated wire after being twisted to second heat treatment after the twisting, or subjecting the coated wire during being twisted to second heat treatment simultaneous with the twisting, wherein
the coated wire after being twisted or the coated wire during being twisted is subjected to heat treatment at a temperature of 150° C. or more and 400° C. or less in the second heat treatment.

According to the manufacturing method of supplement 3, the output characteristics of the composite magnetic wire can be enhanced. The reason why the second heat treatment is performed is the same as the above-described method for manufacturing a composite magnetic wire according to an embodiment.

### [Supplement 4]

The method for manufacturing a composite magnetic wire according to any one of supplement 1 to supplement 3, wherein the drawn wire is subjected to heat treatment at a temperature of more than 750° C. and 850° C. or less in the first heat treatment.

According to the manufacturing method of supplement 4, the structure of the core material in the first heat treated material is easily controlled to have the above-described specific structure. The reason why the temperature of the first heat treatment is more than 750° C. and 850° C. or less is the same as the above-described method for manufacturing a composite magnetic wire according to an embodiment.

### [Supplement 5]

The method for manufacturing a composite magnetic wire according to any one of supplement 1 to supplement 4, wherein the obtaining a drawn wire comprises drawing the core material at a rate of work of 10% or more.

According to the manufacturing method of supplement 5, a composite magnetic wire having high output characteristics is easily obtained. The reason why the core material is drawn at a rate of work of 10% or more is the same as the above-described method for manufacturing a composite magnetic wire according to an embodiment.

The present invention is defined by the terms of the claims, rather than the examples above, and is intended to include the meaning equivalent to the scope of claims and all modifications within the scope.

### REFERENCE SIGNS LIST

1 Magnetic wire
2 Composite magnetic wire
10 Structure, 11 α phase, 12 γ phase
20 Grain boundary, 21 High angle grain boundary, 22 Low angle grain boundary
23 Σ3 Grain boundary
30 Core material
40 Coating material
50 Twist mark
D, D1, D2 Diameter, L, L2 Length, r Radius
θ Twisting angle, θt Angle of twist mark

1. A magnetic wire made of an alloy containing iron and cobalt as main components, wherein
the magnetic wire has a structure comprising at least an α phase of the α phase and a γ phase,
the structure has a high angle grain boundary having a misorientation of 15° or more,
a proportion of an area of the α phase relative to a total area of the α phase and the γ phase in a cross section of the magnetic wire is 90% or more,
an average crystal grain size of the α phase in the cross section is 2.5 μm or less, and
a proportion of a length of the high angle grain boundary relative to a total length of grain boundaries in the structure in the cross section is 60% or more.

2. The magnetic wire according to claim 1, wherein the alloy has a composition comprising 40% by mass or more and 70% by mass or less of cobalt, 2% by mass or more and 12% by mass or less of vanadium, and the balance with iron and inevitable impurities.

3. The magnetic wire according to claim 1, wherein the alloy has a composition comprising 40% by mass or more and 70% by mass or less of cobalt and 2% by mass or more and 12% by mass or less of vanadium, and further comprising at least one selected from the group consisting of 0.1% by mass or more and 1.0% by mass or less of silicon, 0.05% by mass or more and 0.5% by mass or less of titanium, 0.2% by mass or more and 1.0% by mass or less of aluminum, and 0.2% by mass or more and 1.2% by mass or less of manganese, and the balance with iron and inevitable impurities.

4. The magnetic wire according to claim 1, wherein the structure has a Σ3 grain boundary, and
a proportion of a length of the Σ3 grain boundary relative to the total length of the grain boundaries is 5% or more.

5. The magnetic wire according to claim 1, wherein a KAM value of the α phase in the cross section is 0.45° or more.

6. The magnetic wire according to claim 1, wherein a diameter of the magnetic wire is 0.1 mm or more and 1.0 mm or less, and
a length of the magnetic wire is 25 mm or less.

7. A composite magnetic wire comprising a core material, and a coating material for covering an outer peripheral surface of the core material, wherein
the core material is made of the magnetic wire according to claim 1, and
a proportion of a diameter of the core material relative to a diameter of the composite magnetic wire is 45% or more and 95% or less.

8. The composite magnetic wire according to claim 7, wherein a melting point of the coating material is more than 850° C.

9. The composite magnetic wire according to claim 7, wherein a Vickers hardness of the coating material is 200 HV or more.

10. The composite magnetic wire according to claim 7, wherein an outer peripheral surface of the coating material has a twist mark, and
an angle of the twist mark relative to an axis line of the composite magnetic wire is 4° or more and 60° or less.

11. A method for manufacturing a magnetic wire, comprising:
drawing a material made of an alloy containing iron and cobalt as main components to obtain a drawn wire,
subjecting the drawn wire to first heat treatment to obtain a first heat treated material, and
twisting the first heat treated material, wherein
the first heat treatment is performed under such conditions that a structure of the alloy of the first heat treated material comprises an α phase and a γ phase and a proportion of an area of the α phase relative to a total area of the α phase and the γ phase in a cross section of the first heat treated material is 90% or more.

12. The method for manufacturing a magnetic wire according to claim 11, wherein the twisting is performed under such conditions that an amount of strain on a surface of the twisted first heat treated material is 1.0 or more and 4.5 or less.

13. The method for manufacturing a magnetic wire according to claim 11, comprising:
subjecting the first heat treated material after being twisted to second heat treatment after the twisting, or subjecting the first heat treated material during being twisted to second heat treatment simultaneous with the twisting, wherein
the first heat treated material after being twisted or the first heat treated material during being twisted is subjected to heat treatment at a temperature of 150° C. or more and 400° C. or less in the second heat treatment.

14. The method for manufacturing a magnetic wire according to claim 11, wherein the drawn wire is subjected to heat treatment at a temperature of more than 750° C. and 850° C. or less in the first heat treatment.

15. The method for manufacturing a magnetic wire according to claim 11, wherein the obtaining a drawn wire comprises drawing the material at a rate of work of 10% or more.

16. A method for manufacturing a composite magnetic wire, comprising:
coating an outer peripheral surface of a core material made of an alloy containing iron and cobalt as main components with a coating material to obtain a coated wire,
drawing the coated wire to obtain a drawn wire,
subjecting the drawn wire to first heat treatment to obtain a first heat treated material, and
twisting the first heat treated material, wherein
the first heat treatment is performed under such conditions that a structure of the alloy of the core material in the first heat treated material comprises an α phase and a γ phase and a proportion of an area of the α phase relative to a total area of the α phase and the γ phase in a cross section of the core material is 90% or more.

17. The method for manufacturing a composite magnetic wire according to claim 16, wherein the twisting is performed under such conditions that an amount of strain on a surface of the twisted first heat treated material is 0.8 or more and 3.0 or less.

18. The method for manufacturing a composite magnetic wire according to claim 16, comprising:
subjecting the first heat treated material after being twisted to second heat treatment after the twisting, or subjecting the first heat treated material during being twisted to second heat treatment simultaneous with the twisting, wherein
the first heat treated material after being twisted or the first heat treated material during being twisted is subjected to heat treatment at a temperature of 150° C. or more and 400° C. or less in the second heat treatment.

19. The method for manufacturing a composite magnetic wire according to claim 16, wherein the drawn wire is subjected to heat treatment at a temperature of more than 750° C. and 850° C. or less in the first heat treatment.

20. The method for manufacturing a composite magnetic wire according to claim 16, wherein the obtaining a drawn wire comprises drawing the core material of the coated wire at a rate of work of 10% or more.
